(19) United States
(12) Patent Application Publication
(10) Pub. No.: US 2015/0017856 A1
(43) Pub. Date: Jan. 15, 2015

(54) ARTICLE INCLUDING INTUMESCENT COATING, PROCESS FOR FORMING AND USE OF SAME

(71) Applicant: NATIONAL INSTITUTE OF STANDARDS AND TECHNOLOGY, GAITHERSBURG, MD (US)

(72) Inventors: RICK DOWELL DAVIS, IJAMSVILLE, MD (US); YU-CHIN LI, WASHINGTON (TW)

(21) Appl. No.: 14/497,951

(22) Filed: Sep. 26, 2014

Related U.S. Application Data
(60) Provisional application No. 62/033,780, filed on Aug. 6, 2014.

(51) Int. Cl. C09D 5/18

(52) U.S. Cl. CPC C09D 5/185
USPC 442/138; 428/331; 428/319.3; 428/328; 252/606

(57) ABSTRACT

An article includes a substrate and an intumescent coating to form an intumescent product in response to heating the article. The intumescent coating is disposed on the substrate and includes a primary intumescent precursor and a layered material that includes a silicate mineral, a layered double hydroxide, or a combination thereof. The primary intumescent precursor includes a carbohydrate polymer. A process for forming an article includes forming a liquid composition by disposing in a solvent a primary intumescent precursor and a layered material, contacting a substrate with the liquid composition, and forming an intumescent coating on the substrate to form the article.

### CROSS REFERENCE TO RELATED APPLICATIONS

This application claims the benefit of U.S. Provisional Patent Application Ser. No. 62/033,780 filed Aug. 6, 2014, the disclosure of which is incorporated herein by reference in its entirety.

### STATEMENT REGARDING FEDERALLY SPONSORED RESEARCH

This invention was made with United States government support from the National Institute of Standards and Technology. The government has certain rights in the invention.

### BACKGROUND

Reduction in flammability of consumer goods has occurred over the past century. However, certain residential upholstered furniture is implicated in a high proportion of fire losses due to its flammability that plays a role in rapid fire growth that leads to flashover. Flashover is a condition that results in spontaneous ignition of objects proximate to a burning item.

Accordingly, articles and processes for mitigating flammability would be well received in the art.

### BRIEF DESCRIPTION

The above and other deficiencies are overcome by, in an embodiment, an article comprising: a substrate; and an intumescent coating to form an intumescent product in response to heating the article, the intumescent coating being disposed on the substrate and comprising: a primary intumescent precursor comprising a carbohydrate polymer; and a layered material comprising a silicate mineral, a layered double hydroxide, or a combination comprising at least one of the foregoing.

Further disclosed is a composition comprising: a solvent; a primary intumescent precursor to contact a substrate and to form an intumescent coating on the substrate, the primary intumescent precursor being disposed in the solvent and comprising a carbohydrate polymer; and a layered material to be dispersed among the primary intumescent precursor in the intumescent coating on the substrate, the layered material being disposed in the solvent and comprising a silicate mineral, a layered double hydroxide, or a combination comprising at least one of the foregoing.

Additionally disclosed is a process for forming an article, the process comprising: forming a liquid composition by: disposing in a solvent a primary intumescent precursor comprising a carbohydrate polymer; and disposing in the solvent a layered material comprising a silicate mineral, a layered double hydroxide, or a combination comprising at least one of the foregoing; contacting a substrate with the liquid composition; and forming an intumescent coating on the substrate to form the article.

### BRIEF DESCRIPTION OF THE DRAWINGS

The following descriptions should not be considered limiting in any way. With reference to the accompanying drawings, like elements are numbered alike:

FIG. 1 shows a cross-section of an article;

FIG. 2 shows a cross-section of an article;

FIG. 3 shows a micrograph of an article according to Example 1;

FIG. 4 shows a higher magnification micrograph of the article shown in FIG. 3;

FIG. 5 shows a graph of intensity versus energy obtained from Energy-dispersive X-ray spectroscopy (EDEX) of the article according to Example 1;

FIG. 6 shows a graph of heat release rate (HRR) versus time for the article according to Example 1;

FIG. 7 shows a graph of total mass loss versus test duration for a comparative foam according to Example 2; and

FIG. 8 shows a graph of total mass loss versus test duration for the article according to Example 1.

### DETAILED DESCRIPTION

A detailed description of one or more embodiments is presented herein by way of exemplification and not limitation.

It has been found that article that includes an intumescent coating that includes a carbohydrate polymer and a layered material disposed on a substrate and formed, e.g., by dipping the substrate into a liquid composition has a substantially reduced flammability with respect to the substrate without the intumescent coating.

According to an embodiment, an intumescent coating responds to presence of heat to produce an incombustible residue referred to as char that expands and forms an incombustible foam that has fire insulation properties. The intumescent coating includes a carbon source, an acid source, and a blowing agent. Without wishing to be bound by theory, it is believed that the acid, in response to being heated, catalyzes dehydration of the carbon source, and the carbon source is converted to a carbon char. The blowing agent releases a nonflammable gas in response to being heated, and the nonflammable gas contributes to forming the incombustible foam. Accordingly, components of the intumescent coating form an intumescent product (e.g., the incombustible char and incombustible foam) when heated to a temperature that is greater than or equal to a temperature for activating the acid source to catalyze formation of char from the carbon source.

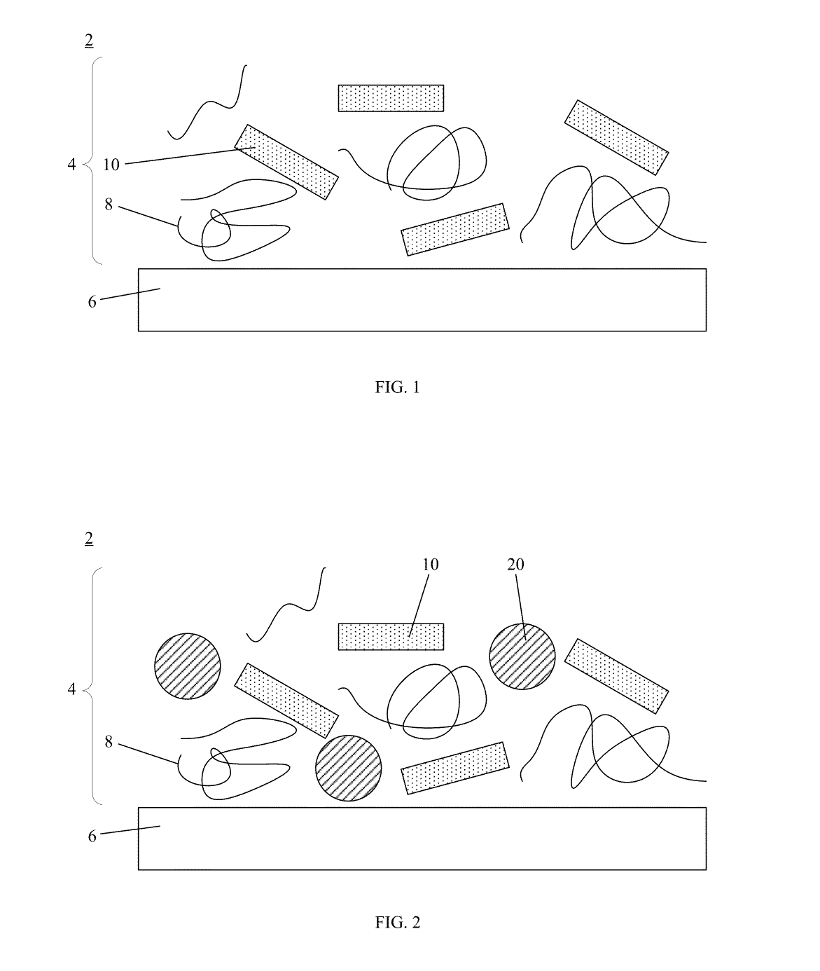

According to an embodiment, as shown in FIG. 1, article 2 includes intumescent coating 4 disposed on substrate 6. Intumescent coating 4 includes primary intumescent precursor 8 and layered material 10. Intumescent coating 4 forms an intumescent product in response to heating article 2.

In an embodiment, as shown in FIG. 2, article 2 includes intumescent coating 4 disposed on substrate 6. Intumescent coating 4 includes primary intumescent precursor 8, layered material 10, and secondary intumescent precursor 20. Intumescent coating 4 forms an intumescent product in response to heating article 2.

In some embodiments, intumescent coating 4 includes an additive.

According to an embodiment, primary intumescent precursor 8 includes a carbohydrate polymer, and layered material 10 includes a silicate mineral, layered double hydroxide, or a combination thereof.

Substrate 6 includes a polymer, textile, metal, glass, ceramic, or a combination thereof.

In an embodiment, substrate 6 includes the polymer, and the polymer is a thermoset, thermoplastic, or a combination thereof. A “thermoset polymer” solidifies when first heated under pressure and thereafter may not melt or mold without destroying original characteristics of the thermoset polymer. Thermosetting polymeric materials include epoxides, phenolics, melamines, ureas, polyurethanes, polysiloxanes, or polymers including a suitable cross-linkable functional moiety.

A thermoplastic polymer has a macromolecular structure that repeatedly softens when heated and hardens when cooled. Illustrative examples of thermoplastic polymeric materials include olefin-derived polymers, e.g., polyethylene, polypropylene, and their copolymers; polymethylpentane-derived polymers, e.g., polybutadiene, polyisoprene, and their copolymers; polymers of unsaturated carboxylic acids and their functional derivatives, e.g., acrylic polymers such as poly(alkyl acrylates), poly(alkyl methacrylate), polyacrylamides, polyacrylonitrile, and polyacrylic acid; alkenylaromatic polymers, e.g., polystyrene, poly-alpha-methylstyrene, polyvinyltoluene, and rubber-modified polystyrenes; polyamides, e.g., nylon-6, nylon-66, nylon-11, and nylon-12; polyesters, such as, poly(alkylene dicarboxylates), including poly(ethylene terephthalate) (PET), poly(1,4-butylene terephthalate) (PBT), poly(trimethylene terephthalate) (PTT), poly(ethylene naphthalate) (PEN), poly(butylene naphthalate) (PBN), poly(cyclohexanedimethanol terephthalate), poly(cyclohexanedimethanol-co-ethylene terephthalate) (PETG), and poly(1,4-cyclohexanedimethyl-1,4-cyclohexanedicarboxylate) (PCCD), and poly(alkylene arenedioates); polycarbonates; co-polycarbonates; co-polyestercarbonates; polysulfones; polyimides; polyarylene sulfides; polysulfide sulfones; and polyethers such as polyarylene ethers, polyphenylene ethers, polyethersulfones, polyetherimides, polyetherketones, polyetheretherketones; or blends or copolymers thereof.

Examples of the polymer include polyurethanes, epoxies, ethylene propylene diene rubber (EPR), ethylene propylene diene monomer rubber (EPDM), melamines, polyacetals, polyacrylamides, polyacrylics such as polyacrylic acid, polyacrylonitriles, polyamides, including polyamideimide, polyarylene ethers, polyarylene sulfides, polyarylene sulfones, polybenzoxazoles, polybenzothiazole, polybutadienes and copolymers thereof, polycarbonates, polycarbonate esters, polyether ketones, polyether ether ketones, polyether ketone ketones, polyethersulfones, polyesters, polyimides such as polyetherimides, polyisoprenes and copolymers thereof, polyolefins such a polyethylene and copolymers thereof, polypropylene and copolymers thereof, and polytetrafluoroethylene, polyphosphazenes, poly(alkyl) (meth)acrylates, polystyrenes and copolymers thereof, rubber-modified polystyrenes such as acrylonitrile-butadiene-styrene (ABS), styrene-ethylene-butadiene (SEB), and methyl methacrylate-butadiene-styrene (MBS), polyoxadiazoles, polysilazanes, polysulfones, polysulfonamides, polyvinyl acetates, polyvinyl chlorides, polyvinyl esters, polyvinyl ethers, polyvinyl halides, polyvinyl nitriles, polyvinyl thioethers, polyureas, polyurethanes, and silicones. A combination comprising at least one of the foregoing polymers can be used. In an embodiment, the polymer is polyurethane.

According to an embodiment, substrate 6 is the polymer, and the polymer comprises a foam. The film is open cell, closed cell, or combination thereof. In an embodiment, the polymer is a foam that includes polyurethane having open cell to exhibit fluid permeability therethrough.

In an embodiment, substrate 6 includes the textile. The textile refers to a woven or non-woven material that includes a network of a plurality of fibers. Textiles can be made directly from fibers or a web of fibers or from yarn comprising a plurality of fibers. Textiles include clothes and fabrics. The fibers can be a material characterized as an animal material (e.g., wool, silk, and the like), plant material (e.g., cotton, flax, jute, bamboo, and the like), mineral material (e.g., asbestos, glass fiber, and the like), synthetic material (e.g., nylon, polyamide, polyester, and acrylic), and the like. The textile can be a non-mineral material such that the textile contains less than or equal to 10 weight-percent (wt %), specifically 5 wt % or less, more specifically 1 wt % or less, and further specifically 0 wt % mineral fibers, based on a total weight of the textile.

According to an embodiment, the textile is drapable. As used herein, “drapable” means that the textile is foldable (i.e., capable of folding) over an object, hanging loosely under the textile's own weight, or shapably conformable to substrate 6. A drapable textile can be used for clothing, upholstery, window drapes, curtains, and the like. In certain embodiments, e.g., the textile is non-drapable, i.e., not drapable.

In some embodiments, the textile includes fibers such as an animal or plant fiber. Such textiles can be a natural textile since the textile is made of fibers from a naturally occurring material. In an embodiment, a natural textile has a different burning characteristic than a synthetic material. It is contemplated that a synthetic material can melt due to heat, e.g., from a flame, rather than char or combust. It also is contemplated that natural material can burn or char rather than melt.

According to an embodiment, the textile is tear, heat, abrasion resistant material such as aramid fibers or polybenzamidazole fibers. Commercially available aramid materials include NOMEX and KEVLAR (both trademarks of E.I. DuPont de Nemours & Co., Inc. of Wilmington, Del.), and commercially available polybenzamidazole fibers include PBI fibers (a trademark of PBI Performance Fabrics of Charlotte, N.C.). Thus, the textile can be an aramid material, a blend of aramid materials, a polybenzamidazole material, a blend of aramid and polybenzamidazole materials, or other material such as BASOFIL (trade name material available from Basofil Fibers, LLC of Enka, N.C.), ZYLON (trade name material available form Toyo Boseki Babushiki Kaisha of Osaka, Japan), and the like.

The textile can exhibit resistance to absorption of water or other moisture and can include a water repellent material such as a polymer, e.g., a perfluorohydrocarbon such as TEFLON (trade name material available from E.I. Du Pont de Nemours and Company of Wilmington, Del.), polytetrafluoroethylene (PTFE) such as GORE-TEX CROSSTECH, or CHEMP AK materials (all three of which are trademarks of WI. Gore & Associates, Inc. of Newark, Del.), polyurethane-based materials, neoprene-based materials, cross-linked polymers, polyamide, and the like.

In an embodiment, substrate 6 includes the metal. Exemplary metals include a metal from the periodic table or an alloy of a plurality of metals from the periodic table. Metals include, for example, magnesium, aluminum, titanium, manganese, iron, cobalt, nickel, copper, molybdenum, tungsten, palladium, chromium, ruthenium, gold, silver, zinc, zirconium, vanadium, silicon, or a combination thereof, including alloys thereof. Particularly, the metal can be an aluminum-based alloy, magnesium-based alloy, tungsten-based alloy, cobalt-based alloy, iron-based alloy, nickel-based alloy, cobalt and nickel-based alloy, iron and nickel-based alloy, iron and cobalt-based alloy, copper-based alloy, and titanium-based alloy. As used herein, the term “metal-based alloy” means a metal alloy wherein the weight percentage of the specified metal in the alloy is greater than the weight percentage of any other component of the alloy, based on the total weight of the alloy.

In an embodiment, substrate 6 includes the glass. The glass can be a silicon oxide-containing material in a solid, amorphous state without crystallization. Such glass has a high degree of microstructural disorder due to a lack of long-range order. The glass can include an oxide, for example, silicon dioxide (Sift), aluminum oxide (Al₂O₃), barium oxide (BaO), bismuth trioxide (Bi₂O₃), boron oxide (B₂O₃), calcium oxide (CaO), cesium oxide (CsO), lead oxide (PbO), strontium oxide (SrO), rare earth oxides (e.g., lanthanum oxide (La₂O₃), neodymium oxide (Nd₂O₃), samarium oxide (Sm₂O₃), cerium oxide (CeO₂)), and the like.

An exemplary glass is Sift (e.g., quartz, cristobalite, tridymite, and the like). The glass can include Sift and other components such as elements, for example, aluminum, antimony, arsenic, barium, beryllium, boron, calcium, cerium, cesium, chromium, cobalt, copper, gallium, gold, iron, lanthanum, lead, lithium, magnesium, manganese, molybdenum, neodymium, nickel, niobium, palladium, phosphorus, platinum, potassium, praseodymium, silver, sodium, tantalum, thorium, titanium, vanadium, zinc, zirconium, and the like. The elements can occur in the glass in the form of oxides, carbonates, nitrates, phosphates, sulfates, or halides. Furthermore, the element can be a dopant in the glass. Exemplary doped glass includes borosilicate, borophosphosilicate, phosphosilicate, colored glass, milk glass, lead glass, optical glass, and the like.

In an embodiment, the glass can include non-amorphous, crystalline domains. Such glass can be, for example, a salt or ester of orthosilicic acid or a condensation product thereof, e.g., a silicate. Exemplary silicates are cyclosilicates, inosilicates, mesosilicates, orthosilicates, phyllosilicates, sorosilicates, tectosilicates, and the like. These glasses have a structure based on silicon dioxide or isolated or linked [SiO₄]⁴⁻ tetrahedral and include other components such as, for example, aluminum, barium, beryllium, calcium, cerium, iron, lithium, magnesium, manganese, oxygen, potassium, scandium, sodium, titanium, yttrium, zirconium, zinc, hydroxyl groups, halides, and the like.

In an embodiment, substrate 6 includes the ceramic. The ceramic is not particularly limited and can be selected depending on a particular application of article 2. Examples of the ceramic include an oxide-based ceramic, nitride-based ceramic, carbide-based ceramic, boride-based ceramic, silicide-based ceramic, or a combination thereof. In an embodiment, the oxide-based ceramic is silica (SiO₂) or titania (TiO₂). The oxide-based ceramic, nitride-based ceramic, carbide-based ceramic, boride-based ceramic, or silicide-based ceramic can contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like).

In an embodiment, primary intumescent precursor 8 includes the carbohydrate polymer, which is a polysaccharide, nucleic acid, or a combination thereof. The polysaccharide includes a plurality of sugar monomers. The nucleic acid includes a plurality of sugar monomers and nucleobase monomers.

In an embodiment, the polysaccharide is formed from two or more monosaccharides joined by glycosidic bonds. Polysaccharides formed from 3-10 monosaccharides can be referred to as oligosaccharides. According to an embodiment, the carbohydrate polymer includes a sugar monomer such as a sugar furanosyl ring or a pyranosyl ring), a modified sugar, an acyclic group (e.g., an acyclic ether, an acyclic mercaptan, an acyclic (e.g., linear or branched) sugar, and the like), and the like. The modified sugar is a chemically-modified furanosyl sugar or a non-furanosyl sugar, a furanosyl sugar analog, a derivative including a bicyclic sugar, a morpholino, tetrahydropyran, a cyclohexenyl, a cyclohexitol, a 2′-modified sugar, 3′-modified sugar a 4′-modified sugar, a 5′-modified sugar, a substituted compound of any of the foregoing modified sugars, or the like. Further, the modified sugar includes a structure that replaces a furanose ring of a naturally occurring nucleoside. In certain embodiments, the modified sugar is a non-furanose ring (e.g., a six-membered ring), or a group having a plurality of rings (fused, non-fused, or spiro).

In some embodiments, the sugar monomer is a sugar such as a ribose, deoxyribose, or dideoxyribose. In an embodiment, the sugar monomer includes a derivative of ribose, deoxyribose, or dideoxyribose. Such derivatives include, e.g., replacement or deletion of a carbon or oxygen atom in a ring of the sugar with a different atom (e.g., a heteroatom or carbon), inclusion of a double bond in the ring, inclusion of a functional group attached to an atom in the ring, or replacement of the ring structure of a cyclic sugar with an acyclic structure. It is contemplated that any of the ring carbons in the sugar is substituted with a functional group (e.g., alkoxy), or OH or H is attached to the ring carbon atom. In some embodiments, the hydrogen or hydroxyl group of a ring carbon is modified or replaced with an oxy group, e.g., a functional group containing oxygen, or a protecting group.

Exemplary functional groups include alkenyl, alkoxy or aryloxy (e.g., OR, wherein R is H, alkyl, cycloalkyl, aryl, aralkyl, heteroaryl or sugar), alkyl alkylamino, alkyl-thio-alkyl, alkynyl, amide (e.g., NHC(O)R, wherein R is alkyl, cycloalkyl, aryl, aralkyl, heteroaryl or sugar), amino (e.g., NH₂; alkylamino, heterocyclyl, arylamino, heteroaryl amino, or amino acid), aryl, arylamino, cyano, cycloalkyl, halo (e.g., F), heteroaryl amino, N₃, heterocyclyl, mercapto, thioalkoxy, or thioalkyl, which is optionally substituted.

In some embodiments, the sugar monomer of the carbohydrate polymer is a sugar or sugar derivative having a cyclic structure as follows:

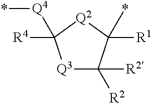

wherein * (asterisk) is a point of attachment;

Q² and Q³ are independently O, S, Se, NR, CR₂, or C═CR₂;

Q⁴ is O, S, NR, CR₂, CR₂CR₂, CR₂O, CR₂OCR₂, CR₂S, CR₂SCR₂, CR₂NR, CR₂NRCR₂, alkenylene, alkylene, alkyleneoxy, alkynylene, amide, amine, aralkylene, arylene, aryleneoxy, cycloalkylene, fluoroalkylene, heteroaralkylene, heteroarylene, heterocycloalkylene, or a single bond;

R¹, R², R^{2′}, and R⁴ are independently R, OR, SR, NR², NROR, NRNR₂, N₃, NO₂, CHO, CN, C(═O)NH₂, or C(═O)OR; alternatively, R² and R^{2′} together are ═O, ═S, ═N—R, or ═CR₂; and

R is independently H, F, Cl, Br, I, OH, SH, NHOH, NHNH₂, CHO, C(═O)OH, alkenyl, alkenyleneamine, alkoxy, alkyl, alkyleneamine, alkynyl, amine, amino, aralkyl, aralkyloxy, aralkyloxy, aryl, aryleneamine, aryloxy carbocyclic, carboxylic acid group or salt, cycloalkyl, cycloalkyloxy, haloalkyl, heteroaralkyl, heteroaryl, or heterocycloalkyl.

Exemplary Q⁴ groups include —O—, —NH—, —S—, —C(O)—, C(O)—NH, NH—C(O)—NH, O—C(O)—NH, —C(S)—, —CH₂—, —CH₂—CH₂—, —CH₂—CH₂—CH₂—, —CH₂—CH₂—CH₂—CH₂—, —O—CH₂—, —CH₂—O—, —O—CH₂—CH₂—, —CH₂—O—CH₂—, —CH₂—CH₂—O—, —O—CH₂—CH₂—CH₂—, —CH₂—O—CH₂—CH₂—, —CH₂—CH₂—O—CH₂—, —CH₂—CH₂—CH₂—O—, —O—CH₂—CH₂—CH₂—CH₂—, —CH₂—O—CH₂—CH₂—CH₂—, —CH₂—CH₂—CH₂—O—CH₂—CH₂—, —CH₂—CH₂—CH₂—O—CH₂—, —CH₂—CH₂—CH₂—CH₂—O—, —C(O)—NH—CH₂—, —C(O)—NH—CH₂—CH₂—, —CH₂—C(O)—NH—CH₂—, —CH₂—CH₂—C(O)—NH—, —C(O)—NH—CH₂—CH₂—CH₂—, —CH₂—C(O)—NH—CH₂—CH₂—, —CH₂—CH₂—C(O)—NH—CH₂—, —CH₂—CH₂—CH₂—C(O)—NH—, —C(O)—NH—CH₂—CH₂—CH₂—CH₂—, —CH₂—C(O)—NH—CH₂—CH₂—CH₂—, —CH₂—CH₂—C(O)—NH—CH₂—CH₂—, —CH₂—CH₂—CH₂—C(O)—NH—CH₂—, —CH₂—CH₂—CH₂—C(O)—NH—CH₂—CH₂—, —CH₂—CH₂—CH₂—CH₂—C(O)—NH—, —NH—C(O)—CH₂—, —CH₂—NH—C(O)—CH₂—, —CH₂—CH₂—NH—C(O)—CH₂—, —NH—C(O)—CH₂—CH₂—, —CH₂—NH—C(O)—CH₂—CH₂, —CH₂—CH₂—NH—C(O)—CH₂—CH₂, —C(O)—NH—CH₂—, —C(O)—NH—CH₂—CH₂—, —O—C(O)—NH—CH₂—, —O—C(O)—NH—CH₂—CH₂—, —NH—CH₂—, —NH—CH₂—CH₂—, —CH₂—NH—CH₂—, —CH₂—CH₂—NH—CH₂—, —C(O)—CH₂—, —C(O)—CH₂—CH₂—, —CH₂—C(O)—CH₂—, —CH₂—CH₂—C(O)—CH₂—, —CH₂—CH₂—C(O)—CH₂—CH₂—, —CH₂—CH₂—C(O)—, —CH₂—CH₂—CH₂—C(O)—NH—CH₂—CH₂—NH—, —CH₂—CH₂—CH₂—C(O)—NH—CH₂—CH₂—NH—C(O)—, —CH₂—CH₂—CH₂—C(O)—NH—CH₂—CH₂—NH—C(O)—CH₂—, and the like.

In an embodiment, the sugar monomer is a sugar or sugar derivative having a cyclic structure as follows:

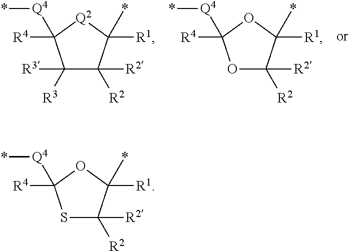

In some embodiments, the sugar monomer is a cyclic structure having an unsaturated bond among the atoms in the cycle as in a following structure:

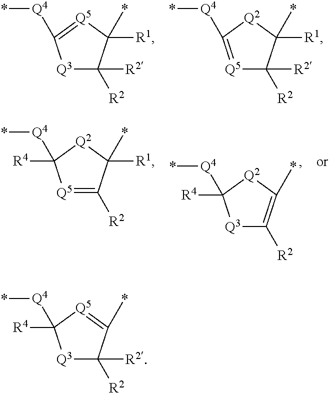

Exemplary sugar monomers with a cyclic ring structure include

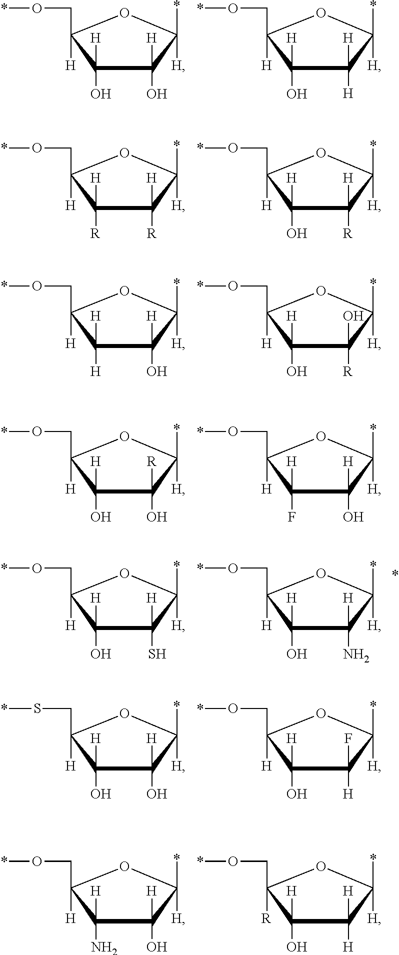

and the like.

According to an embodiment, the sugar monomer includes an acyclic group. The acyclic group can be represented by a structure wherein a bond between atoms in, e.g., ribose ring (e.g., C1′-C2′, C2′-C3′, C3′-4′, C4′-O4′, C1′-O4′) or a ring atom (e.g., C1′, C2′, C3′, C4′ or O4′) independently is absent.

Exemplary sugar monomers having an acyclic structure include

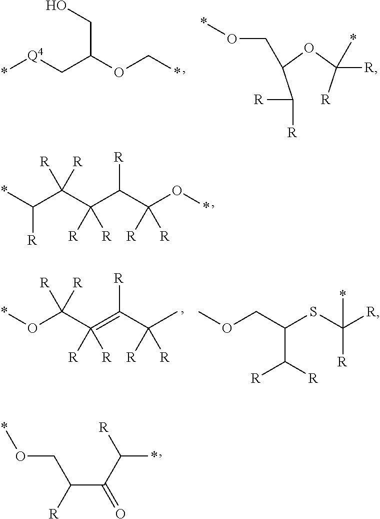

or the like.

According to an embodiment, the polysaccharide is, e.g., an arabinan, fructan, fucan, fucoidan, galactan, galacturonan, glucan, inulin, levan, mannan, xylan, and the like. According to an embodiment, the polysaccharide is a homopolymer or a heteropolymer that contains a repeat unit selected from an aldose, ketose, acid, or amine as follows: allose, altrose, arabinose, arginine, asparagine, aspartic acid, cellobiose, cysteine, deoxyribose, dextrose, erythrose, erythrulose, fructose, galactosamine, galactose, galacturonic acid, glucosamine, glucaric acid, gluconic acid, glucosamine, glucose, glucuronic acid, glutamic acid, glutamine, glycine, gulose, guluronic acid, histidine, idose, lactose, lysine, lyxose, maltose, mannitol, mannose, mannuronic acid, neuraminic acid, psicose, ribose, ribulose, serine, sorbitol, sorbose, sucrose, tagatose, talose, threonine, threose, trehalose, tyrosine, xylose, xylulose, and the like.

In an embodiment, the carbohydrate polymer includes a polysaccharide such as an agar, agarose, alginic acid, amino dextran, amylopectin, amylose, carboxydextran, carboxylmethylcellulose, carboxymethyl chitosan, carboxymethylcellulose, carboxypolymethylene, carboxyvinyl polymer, cardlan, carrageenan, cellulose, chitin, chitohexanose, chitosan, chondroitin, dermatan, dextran, dextran aldehyde, dextrin, diethylamino ethyl dextran chloride, ethylhydroxyethylcellulose, ficoll, furcellaran, galactocarolose, gellan gum, glucomannan, glycogen, guar gum, gum arabic, hyaluronic acid, hydroxyethylcellulose, hydroxymethylcellulose, hydroxypropyl methylcellulose, hydroxypropylcellulose, hydroxypropyldextran, hydroxypropylethylcellulose, hydroxypropylmethylcellulose, keratan, maltodextrin, methoxy polyethylene glycol, methoxycellulose, methylcellulose, pectic acid, pectin, pluran, poly(sialic acid), polyethylene glycol, polypropylene glycol, polyvinyl pyrrolidone, polyvinylalcohol, pullulan, pustulan, sodium carboxymethylcellulose, sodium carboxymethyldextran, sodium dextran sulfate, starch, succinylated aminodextran, tamarind seed gum, tragacanth gum, xanthum gum, and the like.

In an embodiment, the polysaccharide is ethyl cellulose, hydroxypropyl ethyl cellulose, cellulose acetate phthalate, cellulose acetate, hydroxypropyl methylcellulose phthalate, or a combination thereof. According to an embodiment, the polysaccharide is chitosan, alginate, carrageenan, pectin, starch, xanthan gum, gum agar, or a combination thereof.

Starch is a glucose-containing polysaccharide that includes amylose, amylopectin, or combination thereof. Amylopectin is a linear chain polysaccharide, and amylopectin is a branched chain polysaccharide. It is contemplated amylopectin may be less soluble in water than amylose due to branching from the polymer backbone. In an embodiment, the starch includes amylose and amylopectin. Starch with a high percentage of amylopectin can thicken a fluid composition but may not form a gel. It is contemplated that presence of a greater concentration of amylopectin in a composition forms a more viscous composition. It is further contemplated that presence of a greater concentration of amylose in a composition forms a mechanically stronger gel.

Pectins occur naturally in plant food products and can be used as a gelling agent, stabilizer, or thickener. Exemplary hemicelluloses and pectins include glucuronoxylans, xylans, mannans, glucomannans, galactoglucomannans, arabinoxylans, galacturonans, rhamnogalacturonan, xyloglucan, and the like.

Gums can be an extract from a plant and include gum tragacanth and guar gum. As highly branched polysaccharides, gums form viscous compositions, trap water among branches, and are useful as a thickener or stabilizer Polysaccharides include those from aquatic sources such as seaweed such as agars, alginates, and carrageenans. Seaweed polysaccharides are classified as gums, can from a gel, and are useful as a gelling agent, thickener, or stabilizer in compositions.

In an embodiment, the carbohydrate polymer of primary intumescent precursor 8 is the nucleic acid that includes the sugar monomer and a nucleobase monomer.

In some embodiments, the nucleobase monomer is a monovalent heterocyclic base of a naturally occurring nucleoside e.g., adenine, cytosine, guanidine, uracil, thymidine. Additionally, the nucleobase monomer is naturally occurring or modified so that the nucleobase monomer includes, e.g., an analog of a naturally occurring nucleoside.

In an embodiment, the nucleobase monomer has a structure as follows:

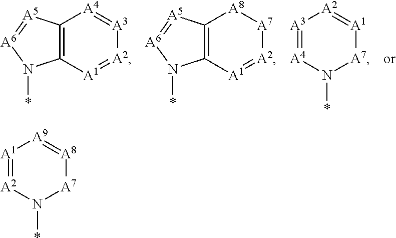

wherein A¹, A², A³, A⁴, A⁵, and A⁶ are independently N, CR¹;

A⁷, A⁸, A⁹ is independently NR¹, C(R¹)₂, C═O, C═C(R¹)₂, C═NR¹; and

R¹ is as defined above.

Specifically, the nucleobase monomer has a structure as follows:

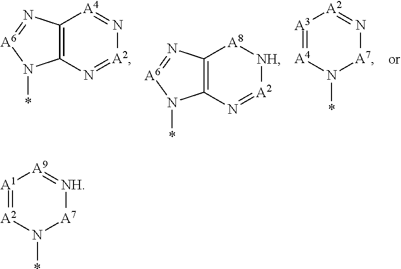

More specifically, the nucleobase monomer has a structure as follows:

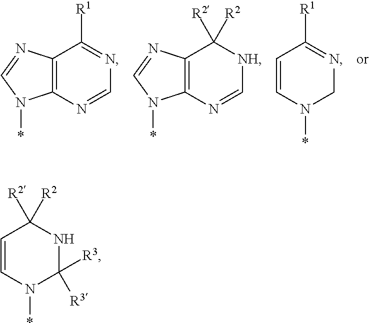

wherein R³ and R^{3′} are independently R, OR, SR, NR₂, NROR, NRNR₂, N₃, NO₂, CHO, CN, C(═O)NH₂, or C(═O)OR; alternatively, R³ and R^{3′} together are ═O, ═S, ═NR, or ═CR₂.

In an embodiment, the nucleobase monomer includes a monovalent species of a purine base (e.g., adenine (A), guanine (G)), a pyrimidine base (e.g., thymine (T), cytosine (C), uracil (U)), or a heterocyclic base that has been modified. Such modifications include a methylated purine or pyrimidine, an acylated purine or pyrimidine, an aminated or alkalyated ribose, or an aminated deoxyribose, or other heterocycle. In some embodiments, the nucleobase monomer includes monovalent species of diaminopurine and its derivatives, inosine and its derivatives, alkylated purines or pyrimidines, acylated purines or pyrimidines, thiolated purines or pyrimidines, and the like, or addition of a protecting group (e.g., acetyl, difluoroacetyl, trifluoroacetyl, isobutyryl, benzoyl, 9-fluorenylmethoxycarbonyl, phenoxyacetyl, dimethylformamidine, dibutylformamidine, N,N-diphenyl carbamate) to the nucleobase monomer.

Further exemplary nucleobase monomers are monovalent species of 1-methyladenine, 1-(aminoalkylamino-carbonylethylenyl)-2(thio)-pseudouracil, 1-(aminoalkylaminocarbonylethylenyl)-2,4-(dithio)pseudouracil, 1-(aminoalkylaminocarbonylethylenyl)-4-(thio)pseudouracil, 1-(aminoalkylaminocarbonylethylenyl)-pseudouracil, 1-(aminocarbonylethylenyl)-2(thio)-pseudouracil, 1-(aminocarbonylethylenyl)-2,4-(dithio)pseudouracil, 1-(aminocarbonylethylenyl)-4-(thio)pseudouracil, 1-(aminocarbonylethylenyl)-pseudouracil, 1-(aza)-2-(thio)-3-(aza)-phenoxazin-1-yl, 1-(aza)-2-(thio)-3-(aza)-phenthiazin-1-yl, 1-methylguanine, 1-methylinosine, 1-methylpseudouracil, 2-(alkyl)adenine, 2-(alkyl)guanine, 2-(amino)adenine, 2-(amino)purine, 2-(aminoalkyll)adenine, 2-(aminopropyl)adenine, 2-(halo)adenine, 2-(methylthio)-N6-(isopentenyl)adenine, 2-(propyl)adenine, 2-(propyl)guanine, 2-(thio)cytosine, 2-(thio)uracil, 2-aminopurine, 2-aza-inosinyl, 2-methyladenine, 2-methylguanine, 2-methylthio-N6-isopentyladenine, 2-pyridinone, 2-thiocytosine, 2-thiouracil, 3-(3-amino-3-carboxypropyl)uracil, 3-(alkyl)cytosine, 3-(deaza)-5-(aza)cytosine, 3-(methyl)-7-(propynyl)isocarbostyrilyl, 3-(methyl)cytosine, 3-(methyl)isocarbostyrilyl, 3-methyl isocarbostyrilyl, 3-methyl-7-propynyl isocarbostyrilyl, 3-methylcytosine, 3-nitropyrrole, 4-(fluoro)-6-(methyl)benzimidazole, 4-(methyl)benzimidazole, 4-(thio)uracil, 4-acetylcytosine, 4-fluoro-6-methylbenzimidazle, 4-methylbenzimidazle, 5-(1,3-diazole-1-alkyl)uracil, 5-(2-aminopropyl)uracil, 5-(2-bromovinyl)uracil, 5-(alkyl)-2-(thio)pseudouracil, 5-(alkyl)-2,4-(dithio)pseudouracil, 5-(alkyl)-4-(thio)pseudouracil, 5-(alkyl)cytosine, 5-(alkyl)pseudouracil, 5-(alkyl)uracil, 5-(alkynyl)cytosine, 5-(alkynyl)uracil, 5-(allylamino)uracil, 5-(aminoalkyl)uracil, 5-(aminoallyl)uracil, 5-(carboxyhydroxymethyl)uracil, 5-(carboxymethylaminomethyl)-uracil, 5-(cyanoalkyl)uracil, 5-(dialkylaminoalkyl)uracil, 5-(dimethylaminoalkyl)uracil, 5-(guanidiniumalkyl)uracil, 5-(halo)cytosine, 5-(halo)uracil, 5-(methoxy)uracil, 5-(methoxycarbonylmethyl)-2-(thio)uracil, 5-(methoxycarbonyl-methyl)uracil, 5-(methyl)-2,5-(methyl)-2-(thio)pseudouracil, 5-(methyl)-2-(thio)uracil, 5-(methyl)-2,4-(dithio)pseudouracil, 5-(methyl)-4-(thio)pseudouracil, 5-(methyl)-4-(thio)uracil, 5-(methyl)cytosine, 5-(methyl)isocarbostyrilyl, 5-(methyl)pseudouracil, 5-(methylaminomethyl)-2,5-(methylaminomethyl)-2-(thio)uracil, 5-(methylaminomethyl)-4-(thio)uracil, 5-(methylaminomethyl)uracil, 5-(propynyl)cytosine, 5-(propynyl)uracil, 5-(trifluoromethyl)cytosine, 5-(trifluoromethyl)uracil, 5-bromouracil, 5-chlorouracil, 5-ethylcytosine, 5-ethyluracil, 5-fluorouracil, 5-hydroxymethyluracil, 5-iodouracil, 5-methoxyuracil, 5-methyl isocarbostyrilyl, 5-methyl-2-thiouracil, 5-methylcytosine, 5-nitroindole, 5-propyluracil, 6-(alkyl)adenine, 6-(alkyl)guanine, 6-(aza)pyrimidine, 6-(azo)cytosine, 6-(azo)thymine, 6-(azo)uracil, 6-(methyl)-7-(aza)indolyl, 6-(methyl)adenine, 6-(methyl)guanine, 6-hydroxyaminopurine, 6-methyl-7-azaindolyl, 6-thiopurine, 7-(alkyl)guanine, 7-(aminoalkylhydroxy)-1-(aza)-2-(thio)-3-(aza)-phenoxazin-1-yl, 7-(aminoalkyl hydroxy)-1-(aza)-2-(thio)-3-(aza)-phenthiazin-1-yl, 7-(aza)indolyl, 7-(deaza)adenine, 7-(deaza)guanine, 7-(guanidiniumalkylhydroxy)-1-(aza)-2-(thio)-3-(aza)-phenoxazin-1-yl, 7-(guanidiniumalkylhydroxy)-1-(aza)-2-(thio)-3-(aza)-phenthiazin-1-yl, 7-(guanidiniumalkylhydroxy)-1,3-(diaza)-2-(oxo)-phenoxazin-1-yl, 7-(methyl)guanine, 7-(propynyl)isocarbostyrilyl, 7-azaindolyl, 7-deaza-inosinyl, 7-methylguanine, 7-propynyl isocarbostyrilyl, 8-(alkenyl)adenine, 8-(alkenyl)guanine, 8-(alkyl)adenine, 8-(alkyl)guanine, 8-(alkynyl)adenine, 8-(alkynyl)guanine, 8-(amino)adenine, 8-(amino)guanine, 8-(halo)adenine, 8-(halo)guanine, 8-(hydroxyl)adenine, 8-(hydroxyl)guanine, 8-(thioalkyl)adenine, 8-(thioalkyl)guanine, 8-(thiol)adenine, 8-(thiol)guanine, 8-aminoguanine, 8-aza-7-deazaadenine, 8-bromoadenine, 8-bromoguanine, 8-chloroguanine, 8-methylguanine, 8-thioguanine, 9-(methyl)-imidizopyridinyl, aminoindolyl, dihydrouracil, hypoxanthine, imidizopyridinyl, inosine, inosinyl, isocarbostyrilyl, isoguanisine, N-(methyl)guanine, N3-(methyl)uracil, N4-(acetyl)cytosine, N6-(isopentyl)adenine. N6-(methyl)adenine, N6-isopentyladenine, N6-methyladenine, nitrobenzimidazolyl, nitroimidazolyl, nitroindazolyl, nitroindolyl, nitropyrazolyl, nubularine, propynyl-7-(aza)indolyl, pseudouracil, pyrrolopyrimidinyl, pyrrolopyrizinyl, queosine, tubercidine, uracil-5-oxyacetic acid, uracil-5-oxyacetic acid methyl ester, xanthine, 1,3-(diaza)-2-(oxo)-phenoxazin-1-yl, 1,3-(diaza)-2-(oxo)-phenthiazin-1-yl, 1,3,5-(triaza)-2,6-(dioxa)-naphthalene, 2,2-dimethylguanine, 2,4-(dithio)pseudouracil, 2,4,5-(trimethyl)phenyl-4-(methyl)indolyl, 2,6-(diamino)purine, 2,6-diaminopurine, 4-(dithio)uracil, 4,6-(dimethyl)indolyl, 4,6-dimethylindolyl, 7-(aminoalkylhydroxy)-1,3-(diaza)-2-(oxo)-phenoxazin-1-yl, 7-(aminoalkylhydroxy)-1,3-(diaza)-2-(oxo)-phenthiazin-1-yl, 7-(guanidiniumalkyl-hydroxy)-1,3-(diaza)-2-(oxo)-phenthiazin-1-yl, N,N-dimethyladenine, N6,N6-(dimethyl)adenine, and the like. It is contemplated that any of the above nucleobase monomers can be modified as an analog or substituted, e.g., O-alkylated, N-alkylated, or a halogenated.

According to an embodiment, the nucleic acid includes a plurality of nucleotides bonded together. The nucleotides include the nucleobase monomer bonded to the sugar monomer, which is bonded to a phosphate group. Exemplary nucleic acids include ribonucleotides and deoxyribonucleotides such as adenosine monophosphate (AMP), cytosine monophosphate (CMP), guanosine monophosphate (GMP), uracil monophosphate (UMP), deoxyadenosine monophosphate (dAMP), deoxycytosine monophosphate (dCMP), deoxyguanosine monophosphate (dGMP), deoxythymine monophosphate (dTMP), and monophosphates of any combination of the sugar monomer bonded to the nucleobase monomer recited above. Additionally, the nucleic acid includes non-canonical nucleoside monophosphates (e.g., inosine and xanthine).

Secondary intumescent precursor 20 includes a polymer, a blowing agent, cross-linker, acid source, polypeptide or a combination thereof.

The polymer can be a polymer recited above for substrate 6. In an embodiment, substrate 6 includes a first polymer, and secondary intumescent precursor 20 includes a second polymer. The first polymer and second polymer independently can be a polymer recited above for substrate 6. Accordingly, the first polymer and second polymer are the same in an embodiment. In some embodiments, the first polymer and the second polymer are different.

In some embodiments, the polymer of secondary intumescent precursor 20 has a chemical polarity or a plurality of charged groups suitable for bonding or interacting through attractive electrostatic interactions with substrate 6 or other components in the intumescent coating 4 such as primary intumescent precursor 8, another secondary intumescent precursor 20, and the like. The polymer is neutral in charge or has a net positive or negative charge.

Examples of such a polymer are a polycation, polyanion, or polar polymer. In one embodiment, the polymer can be cross-linked to provide stretchability to intumescent coating 4 in order to accommodate a surface strain experienced by a flexible substrate 6 or a thermally expanding article 2. Exemplary polymers can include thermoplastics, thermosets, and polyelectrolytes (including polyampholytes), such as, without limitation, polycarbonate, poly(acrylic acid), poly(methacrylic acid), polyoxide, polysulfide, polysulfone, fluoropolymers (e.g., polytetrafluoroethylene), polyamide, polyester, polyurethane, polyimide, poly(vinyl acetate), poly(vinyl alcohol), poly(vinyl chloride), poly(vinyl pyridine), poly(vinyl pyrrolidone), epoxies, polyethylene imine, polypropylene imine, polyethylene polyamine, polypropylene polyamine, polyvinylamine, polyallylamine, chitosan, polylysine, protamine sulfate, poly(methylene-co-guanidine) hydrochloride, polyethylenimine-ethoxylated, quaternized polyamide, polydiallyidimethyl ammonium chloride-co-acrylamidem poly(diallyidimethylammonium chloride), poly(vinylbenzyltrimethyl-ammonium), poly(acryloxyethyltrimethyl ammonium chloride), poly(methacryloxy(2-hydroxy)propyltrimethyl ammonium chloride), poly(N-methylvinylpyridine), poly(allylaminehydrochloride), copolymers thereof, and combinations thereof. Exemplary polymers also include elastomers, specifically polar fluoroelastomers. Exemplary fluoroelastomers are copolymers of vinylidene fluoride and hexafluoropropylene and terpolymers of vinylidene fluoride, hexafluoropropylene and tetrafluoroethylene. The fluoroelastomers can be elastomers that include vinylidene fluoride units (VF2 or VdF), hexafluoropropylene units (HFP), tetrafluoroethylene units (TFE), chlorotrifluoroethylene (CTFE) units, or perfluoro(alkyl vinyl ether) units (PAVE), such as perfluoro(methyl vinyl ether)(PMVE), perfluoro(ethyl vinyl ether)(PEVE), or perfluoro(propyl vinyl ether)(PPVE). These elastomers can be homopolymers or copolymers. Specifically exemplary polymers are fluoroelastomers containing vinylidene fluoride units, hexafluoropropylene units, or, optionally, tetrafluoroethylene units or fluoroelastomers containing vinylidene fluoride units, perfluoroalkyl perfluorovinyl ether units, tetrafluoroethylene units, and the like. Exemplary polar fluoroelastomers include those commercially available from DuPont or Daikin Industries, Ltd.

In an embodiment, the polymer has a positive charge at a pH of less than 7, specifically less than or equal to 6, more specifically less than or equal to 5, and still more specifically less than or equal to 4. In an embodiment, the polymer has a negative charge at a pH of greater than 7, specifically greater than or equal to 8, more specifically greater than or equal to 9, and still more specifically greater than or equal to 10.

Negatively charged polymers include polycarboxylic acids such as poly(meth)acrylic acid, salts thereof, or the like; a polycarboxylic acid copolymer such as a poly((meth)acrylic acid-co-methyl (meth)acrylate) copolymer, poly(styrene-co-(meth)acrylic acid), poly(styrene-co-maleic acid), and the like, and combinations comprising at least one of the foregoing polymers. As used herein, “(meth)acrylic” means “acrylic” or “methacrylic”, and “(meth)acrylate” means “acrylate” or “methacrylate”, unless otherwise specified. Also as used herein, “copolymer” refers to a polymer formed by the reaction of two or more different monomers, and therefore encompasses as well the more specific terms “terpolymer”, “tetrapolymer” and the like. In an exemplary embodiment, the negatively charged polymer is polyacrylic acid, which is water soluble.

In another embodiment, the positively charged polymer is an amine-containing polymer. A polyamine may be used such as those prepared by the polymerization of aziridene and including polyethyleneamines and polyethyleneimines having a branched structure derived from aziridene and tris(aminoethyl)amine; a hyperbranched or dendrimeric polyamine such as polyamidoamine (PAMAM) dendrimer; a polyaminoacrylate such as poly(N,N-dimethylaminoethyl-(meth)acrylate); a copolymer thereof with an alkyl or aralkyl (meth)acrylate such as methyl (meth)acrylate, ethyl (meth)acrylate, butyl (meth)acrylate, cyclohexyl(meth)acrylate, 2-hydroxyethy (meth)acrylate, 2-hydroxypropyl (meth)acrylate, (meth)acrylonitrile, and the like, such as, for example, poly(N,N-dimethylaminoethyl-(meth)acrylate)-co-(methyl(meth)acrylate); combinations comprising at least one of the above polymers, and the like. In an embodiment, the positively charged polymer is polyethyleneimine, which is water soluble.

The blowing agent can be a compound that produces the nonflammable gas, e.g., nitrogen (N₂), nitrogen oxides (NO, NO₂, and the like), ammonia, carbon, carbon oxides (CO, CO₂, and the like), water, and the like.

In an embodiment, the blowing agent is a compound that contains a nitrogen atom in a chain, cycle, heterocycle, or combination thereof. The nitrogen-containing blowing agent is a compound of or a salt having a structure as follows:

O═C—(R^{a})ₘ,

wherein, for each occurrence of R^{a}, R^{a} independently is —H, —NH₂, —N(H)(alkyl), —N(alkyl)₂, —N(H)(aryl), —N(aryl)₂, —CO₂H, —CN, —OH, substituted or unsubstituted alkyl, or substituted or unsubstituted aryl; and

m is an integer from 1 to 2, depending on the valence of R^{a}.

In an embodiment, the nitrogen-containing blowing agent is a compound or a salt thereof having a structure as follows:

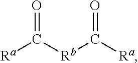

wherein, for each occurrence of R^{a}, R^{a} independently is —H, —NH₂, —N(H)(alkyl), —N(alkyl)₂, —N(H)(aryl), —N(aryl)₂, —CO₂H, —CN, —OH, substituted or unsubstituted alkyl, or substituted or unsubstituted aryl; and

R^{b} is —NH—, —N(alkyl)-, —N(aryl)-, —O—, —C(R¹)₂—, —S—, substituted or unsubstituted alkylene, substituted or unsubstituted arylene, or absent.

In an embodiment, the nitrogen-containing blowing agent is a compound or a salt thereof having a structure as follows:

N≡C—(R^{a})ₘ,

wherein, for each occurrence of R^{a}, R^{a} independently is —H, —NH₂, —N(H)(alkyl), —N(alkyl)₂, —N(H)(aryl), —N(aryl)₂, —CO₂H, —CN, —OH, substituted or unsubstituted alkyl, or substituted or unsubstituted aryl; and

m is an integer from 1 to 2, depending on the valence of R^{a}.

In an embodiment, the nitrogen-containing blowing agent is a compound or a salt thereof having a structure as follows:

Q-(R^{c})ₙ,

wherein Q is a five-, six-, seven-, eight-, nine-, or ten-membered aryl or heteroaryl cyclic group that contains N (nitrogen atoms) in the cycle, e.g., a triazine ring;

for each occurrence of R^{c}, R^{c} independently is —H, —OH, —CO₂H, —NO₂, —CN, substituted or unsubstituted amino, substituted or unsubstituted alkyl, or substituted or unsubstituted aryl; and

n is an integer 0, 1, 2, 3, 4, or 5.

According to an embodiment, the nitrogen-containing blowing agent include any suitable compound that produces N₂ or ammonia, e.g., amines, ureas, guanidines, guanamines, s-triazines, amino acids, and salts thereof including phosphate, phosphonate, phosphinate, borate, cyanurate and sulfate salts, and the like. Exemplary nitrogen-containing blowing agents include glycine, melamine phosphate, melamine pyrophosphate, melamine polyphosphate, ammonium phosphate, ammonium pyrophosphate, ammonium polyphosphate, ethylenediamine phosphate, melamine cyanurate, ammonium cyanurate, melamine borate, ammonium borate, and the like.

Additional exemplary blowing agents that contain nitrogen include 1,1-dimethylhydrazine, 2-cyanoguanidine, 5-aminotetrazole, acesulfame potassium, acetaldoxime, acetone oxime, allophante, aminoacetonitrile, aminoethylpiperazine, ammelide, ammeline, aspartame, azodicarbonamide, benzisothiazolinone, benzoguanamine, benzoguanidine, biurea, biuret, calcium cyanamide, carbohydrazide, chloramine, cyanamide, cyanoethylhydrazine, cyanuric acid, dalfampridine, diazolidinyl urea, diethanolamine, diethyltriamine, dimethylacetamide, dimethylamine, ethylamine, ethylenediamine, ethylhydrazine, formamidoxime, guanidine, guanidine carbonate, hexamethylenetetramine, hydrazine, hydroxylamine, hydroxyurea, imidazolidinyl urea, isothiazole, isothiazolinone, malonamide, malononitrile, melamine, methylamine, methylene blue, nitromethane, piperazine, sodium azide, sodium dicyanamide, sodium thiocyanate, succinonitrile, tetraethylenepentamme, tetranitromethane, tetrazole, thiazole, thioacetamide, thiourea, triethylenetetramine, triethylenetetramine, trimethylamine, trinitromethane, urea, 1,2,3-triazole, 1,2,4-triazole, 1,2-cyclohexanedione dioxime, 1,2-dimethylhydrazine, 1,3,5-triazine, 1,3-diaminoguanidine HCl, 1,3-diaminopropane, 1,3-diaminopropane, and the like.

Exemplary triazines include 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-styryl)-4,6-bis(trichloromethyl)-s-triazine, 2-biphenyl-4,6-bis(trichloromethyl)-s-triazine, bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2-4-trichloromethyl(piperonyl)-s-triazine, and 2-4-trichloromethyl(4′-methoxystyryl)-s-triazine. 1,3,5-triazine-2,4,6-triamine, 4,6-diamino-1,3,5-triazin-2-ol, 6-amino-1,3,5-triazine-2,4-diol, 1,3,5-triazine-2,4,6-triol, 6-phenyl-1,3,5-triazine-2,4-diamine, and the like.

In an embodiment, secondary intumescent precursor includes the polypeptide. The polypeptide includes a plurality of an amino acids bonded together by peptide bonds. The amino acid is a naturally occurring amino acid or a synthetic α, β, γ, or δ amino acid. Additionally, the amino acid includes, amino acids found in proteins, e.g., alanine, arginine, asparagine, aspartate, cysteine, glutamate, glutamine, glycine, histidine, isoleucine, leucine, lysine, methionine, phenylalanine, proline, serine, threonine, tryptophan, tyrosine, valine, and the like. In an embodiment, the amino acid is in an L-configuration. In some embodiments, the amino acid is a derivative of alanyl, argininyl, asparaginyl, aspartoyl, cysteinyl, glutaminyl, glutamyl, glycinyl, histidinyl, leucinyl, lysinyl, methioninyl, phenylalaninyl, prolinyl, serinyl, threoninyl, tryptophanyl, tyrosinyl, valinyl, β-alanyl, β-agininyl, β-asparaginyl, β-aspartoyl, β-cysteinyl, β-glutaminyl, β-glutaroyl, β-glycinyl, β-histidinyl, β-isoleucinyl, β-leucinyl, β-lysinyl, β-methioninyl, β-phenylalaninyl, β-prolinyl, β-serinyl, β-threoninyl, β-tryptophanyl, β-tyrosinyl, β-valinyl. It is contemplated that, the term “amino acid” is an independent disclosure of each of the esters of α, β, γ, or δ forms of alanine, arginine, asparagine, aspartate, cysteine, glutamate, glutamine, glycine, histadine, isoleucine, leucine, lysine, methionine, phenylalanine, proline, serine, threonine, tryptophan, tyrosine, valine in the D and L configurations. Exemplary polypeptides include those containing amine functional groups (e.g., primary amines), acid functional groups, or a combination thereof.

In an embodiment, secondary intumescent precursor 20 includes the cross-linker. The cross-linker can be a hardener, accelerator, catalyst, curative, initiator, and the like, or a combination thereof. It is believed that the cross-linker reacts with functional groups located within intumescent coating 4 such as hydroxyl groups or epoxy groups in various ways that may include cross-linking, adding to a polymer backbone, capping a polymer, and the like. The cross-linker includes a carboxylic acid, amine, amide, phenol, thiol, anhydride, alcohol, or a combination thereof. These cross-linkers can enhance properties such as heat and chemical resistance of the resulting intumescent coating 4 or article 2. The cross-linker can be selected based on an identity of primary intumescent precursor 8 or secondary intumescent precursor 20 as well as the desired properties of article 2.

Examples of the carboxylic acid cross-linker include organic carboxylic acids, hydroxy-carboxylic acids, and dicarboxylic acids, such as formic acid, acetic acid, lactic acid, oxalic acid, and the like.

In an embodiment, the carboxylic acid is a C₂-C₁₂ carboxylic acid. In one embodiment, the carboxylic acid is a dicarboxylic acid or a tricarboxylic acid, preferably a dicarboxylic acid, more preferably a C₄ dicarboxylic acid. The carboxylic acid can be saturated or unsaturated, branched or linear, substituted (e.g., hydroxyl substituted or amino substituted) or unsubstituted.

Exemplary carboxylic acids include malic acid, tartaric acid, propionic acid, butyric acid, ascorbic acid, citric acid, amino acids, chloroacetic acid, dichloroacetic acid, trichloroacetic acid, trifluoroacetic acid, phthalic acid (including ortho-, meta- and para-isomers), and the like.

Suitable C₂-C₆ carboxylic acids for use herein can be straight chain or branched chain alkyl or alkenyl structures or can have a cyclic lactone structure. According to an embodiment, the carboxylic acid is polyfunctional with inclusion of a plurality of carboxyl functional groups such as lactic acid, ascorbic acid, glycolic acid, mevalonic acid, malonic acid and succinic acid. Examples of dicarboxylic acids include, but are not limited to, oxalic acid, malonic acid, succinic acid, fumaric acid, maleic acid, malic acid, tartaric acid, aspartic acid, glutaric acid, glutamic acid, glutaconic acid, adipic acid, muconic acid, suberic acid, itaconic acid, and terephthalic acid. Examples of tricarboxylic acids include, but are not limited to, citric acid, isocitric acid, aconitic acid, propane-1,2,3-tricarboxylic acid, and trimesic acid.

Aromatic carboxylic acids include benzoic acid, orthoatoluic acid, meta-toluic acid, para-toluic acid, ortho-chlorobenzoic acid, meta-chlorobenzoic acid, para-chlorobenzoic acid, ortho-bromobenzoic acid, metabromobenzoic acid, para-bromobenzoic acid, ortho-nitrobenzoic acid, meta-nitrobenzoic acid, para-nitrobenzoic acid, 3,5-dinitrobenzoic acid, salicylic acid, meta-hydroxy-benzoic acid, para-hydroxybenzoic acid, anisic acid, gallic acid, syringic acid, anthranillic acid, meta-aminobenzoic acid, para-aminobenzoic acid, and the like. Polybasic aromatic carboxylic acids include phthalic acid, isophthalic acid, terephthalic acid, hemimellitic acid, trimellitic acid, trimesic acid, prehnitic acid, mellophanic acid, pyromellitic acid, diphenic acid, and the like. In some embodiments, a homolog of the aromatic carboxylic acid is used in a composition to form intumescent coating 4 and includes phenyl acetic acid, hydrocinnamic acid, gamma-phenylbutyric acid, delta-phenyl-n-valeric acid, epsilon-phenyl-n-caproic acid, cinnamic acid, phenylpropiolic acid, homophthalic acid, ortho-phenylenediacetic acid, meta-phenylenediacetic acid, paraphenylenediacetic acid, ortho-phenylene-acetic-beta-propionic acid, and the like.

The amine cross-linker includes a primary, secondary, or tertiary amine, ammonium salt, and the like. Exemplary amine cross-linkers are 1,2-diaminoethane, 1,3-cyclohexanedimethanamine, 2,2′-dimethyl-4,4′ methylenebis(cyclohexylamine), 2,4,6-tris(dimethylaminomethyl)phenol, 2-methylpentamethylenediamine, 2-piperazin-1-ylethylamine, 3-aminomethyl-3,5,5-trimethylcyclohexylamine, 3-aminopropyldimethylamine, 4,4′-diamino diphenylmethane, 4,4′-methylenebis(cyclohexylamine), benzyldimethylamine, bis[(dimethylamino)methyl]phenol, 1,3-benzene dimethanamine, N(3-dimethylaminopropyl)-1,3-propylene diamine, octahydro-4,7-methano-1H-indenedimethylamine, tetraethylenepentamine, isophoronediamine, triethylenetetraamine, diethylenetriamine, aminoethylpiperazine, 1,2-diaminopropane, 1,3-diaminopropane, 2,2-dimethylpropylenediamine, 1,4-diaminobutane, 1,6-diaminohexane, 1,7-diaminoheptane, 1,8-diaminooctane, 1,9-diaminonane, 1,12-diaminododecane, 4-azaheptamethylenediamine, N,N′-bis(3-aminopropyl)butane-1,4-diamine, cyclohexanediamine, dicyandiamine, diamide diphenylmethane, diamide diphenylsulfonic acid (amine adduct), 4,4′-methylenedianiline, diethyltoluenediamine, m-phenylene diamine, melamine formaldehyde, tetraethylenepentamine, 3-diethylaminopropylamine, 3,3′-iminobispropylamine, 2,4-bis(p-aminobenzyl)aniline, tetraethylenepentamine, 3-diethylaminopropylamine, 2,2,4-trimethylhexamethylenediamine, 2,4,4-trimethylhexamethylenediamine, 1,2-trimethylhexamethylenediamine, 1,3-diamino cyclohexane, 1,4-diamino-3,6-diethylcyclohexane, 1,2-diamino-4-ethylcyclohexane, 1,4-diamino-3,6-diethylcyclohexane, 1-cyclohexyl-3,4-diminocyclohexane, 4,4′-diaminodicyclohexylmethane, 4,4′-diaminodicyclohexylpropane, 2,2-bis(4-amino cyclohexyl)propane, 3,3′-dimethyl-4,4′-diaminodicyclohexylmethane, 3-amino-1-cyclohexaneaminopropane, 1,3-bis(aminomethyl)cyclohexane, 1,4-bis(aminomethyl)cyclohexane, m-xylylendiamine, p-xylylendiamine, and the like.

Exemplary anhydride cross-linkers include maleic anhydride, tetrahydrophthalic anhydride, hexahydrophthalic acid, methyltetrahydrophthalic anhydride, methylhexahydrophthalic anhydride, 1,2-cyclohexanedicarboxylic anhydride, bicyclo[2.2.1]hept-5-ene-2,3-dicarboxylic anhydride, methylbicyclo[2.2.1]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, trimellitic anhydride, hexahydrotrimellitic anhydride, methylnadic anhydride, hydro methylnadic anhydride, dodecenyl succinic anhydride, hexahydropyromellitic dianhydride, benzophenonetetracarboxylic dianhydride, styrene-maleic anhydride copolymers, dodecyl succinic anhydride, and the like.

Exemplary isocyanate cross-linkers include toluene diisocyanate, methylene diphenyldiisocyanate, hydrogenated toluene diisocyanate, hydrogenated methylene diphenyldiisocyanate, polymethylene polyphenylene polyisocyanates, isophorone diisocyanate, and the like.

Thiol cross-linkers include polythiol or polymercaptan compounds. In an embodiment, the thiol cross-linker is an alkyl polysulfide, thiuram disulfide, or amine polysulfide. Some non-limiting examples of the thiol cross-linker are 4,4′-dithiomorpholine, dithiodiphosphorodisulfides, diethyldithiophosphate polysulfide, alkyl phenol disulfide, tetramethylthiuram disulfide, 4-morpholinyl-2-benzothiazole disulfide, dipentamethylenethiuram hexasulfide, and caprolactam disulfide. Additional exemplary thiol cross-linkers include aliphatic thiols such as methanedithiol, propanedithiol, cyclohexanedithiol, 2-mercaptoethyl-2,3-dimercapto-succinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, or dipentaerythritol poly(beta-thiopropionate); halogen-substituted derivatives of aliphatic thiols; aromatic thiols such as di-, tri- or tetra-mercaptobenzene, bis-, tris- or tetrakis(mercaptoalkyl)benzene, dimercaptobiphenyl, toluenedithiol, or naphthalenedithiol; halogen-substituted derivatives of aromatic thiols; heterocyclic ring-containing thiols such as amino-4,6-dithiol-sym-triazine, alkoxy-4,6-dithiol-sym-triazine, aryloxy-4,6-dithiol-sym-triazine, or 1,3,5-tris(3-mercaptopropyl)isocyanurate; halogen-substituted derivatives of heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl)disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol or 2,5-dimercapto-1,3,4-thiadiazol; and the like.

Exemplary phenol cross-linkers include hydroquinone, catechol, resorcinol, phloroglucinol, pyrogallol, 1,6-dihydroxy naphthalene, 2,7-dihydroxy naphthalene, 2,6-dihydroxy naphthalene, 1,2,4-trihydroxybenzene, 1,3-dihydroxy naphthalene, 1,4-dihydroxy naphthalene, 1,5-dihydroxy naphthalene, 1,7-dihydroxy naphthalene, 2,3-dihydroxy naphthalene, 1,2-dihydroxy naphthalene, 2-methylresorcinol, 5-methylresorcinol, hexahydroxybenzene, 1,8,9-trihydroxyanthracene, 3-methyl-pyrocatecho, methyl-hydroquinon, 4-methyl-pyrocatecho, 4-benzylresorcinol, 1,1′-bis(2-naphthol), 4,4′-bisphenol, bis(4-hydroxyphenyl)sulfone, and 4-bromoresorcinol, 4,4′-butylidenebis(6-tert-butyl-3-m-cresol), 4-tert-butylcatechol, 2,2′-bisphenol, 4,4′-dihydroxydiphenylmethane, tert-butylhydroquinone, 1,3-bis(4-hydroxyphenoxy)benzene, 1,4-bis(3-hydroxyphenoxy)benzene, 1,1-bis(4-hydroxylphenyl)cyclohexane, bis(4-hydroxyl-3,5-dimethylphenyl)sulfone, 9,9-bis(4-hydroxyphenyl)fluorine), 9,9-bis(4-hydroxyl-3-methylphenyl)fluorine, 4-tert-butyl calix[8]arene, 4-tert-butyl calix[5]arene, 4-tert-butylsulfonyl calix[4] arene, calix[8] arene, calix[4] arene, calix[6] arene, and 4-tety-butyl calix[6] arene, 2,5-bis(1,1,3,3,-tetramethylbutyl)hydroquinone, 2,6-bis[(2-hydroxyl-5-methylphenol)methyl]-4-methylphenol, 1,1-bis(3-cyclohexyl-4-hydroxylphenol)cyclohexane, 1,1-bis(4-hydroxyl-3-methylphenol)cyclohexane, hexestrol, 2′,4′-dihydroxyacetophenone, anthrarufin, chrysazin, 2,4-dihydroxybenzaldehyde, 2,5-dihydroxybenzaldehyde, 3,4-dihydroxybenzaldehyde, ethyl 3,4-dihydroxyaminobenzoate, 2,4-dihydroxybenzophenone, 2,2′-dihydroxy-4,4′-dimethoxy-benzophenone, 4,4′-dihydroxybenzophenone, 4-ethylresorcinol, and phenylhydroquinone, 2,2′-dihydroxy-4-methoxybenzophenone, 2,2′-dihydroxybenzophenone, methyl 2,6-dihydroxyaminobenzoate, 2,3-dihydroxybenzaldehyde, octafluoro-4,4′-bisphenol, 3′,6′-dihydroxybenzoylnorbornene, 2,4′-dihydroxydiphenylmethane, 2′,5′-dihydroxyacetophenone, 3′,5′-dihydroxyacetophenone, 2,4-dihydroxyaminobenzoate, 2-hydroxyethyl-4,4′-dihydroxydiphenyl etherdihydroxydiphenyl ether, 2,2′-dihydroxydiphenyl ether, methyl 3,5-dihydroxyaminobenzoate, 1,4-dihydroxy-2-naphthoate, 3′,4′-dihydroxyacetophenone, 2,4′-dihydroxydiphenyl sulfone, 3,4′-dihydroxybenzyl alcohol, 3,5-dihydroxybenzyl alcohol, 2,4′-dihydroxybenzophenone, 2,6′-dimethyl hydroquinone, 2′,4′-dihydroxypropiophenone, 4,4′-dihydrxytetraphenylmethane, methyl 3,4-dihydroxyphenylacetate, 2,5-dimethylresorcinol, 2-(3,4-dihydroxyphenyl)ethanol, 4,4′-ethylidene bis-phenol, 3,3′-ethylenedioxydiphenol, 4-fluorocatechol, ethyl gallate, methyl gallate, propyl gallate, isoamyl gallate, hexadecyl gallate, dodecyl gallate, stearyl gallate, butyl gallate, isobutyl gallate, n-octyl-4-hexylresorcinol gallate, 4,4′-(2-hydroxybenzilidene)bis(2,3,6-trimethylphenol), 4,4′-methylene-bis-(2,6-di-tert-butylphenol), 2,2′-methylene-bis(6-tert-butyl-4-ethyl phenol), 2,2′-methylene-bis(6-tert-butyl-4-cresol), methoxyhydroquinone, 4,4′-(.alpha.-methylbenzal)bisphenol, 4,4′-methylene-bis(2,6-dimethylphenol), 2,2′-methylene-bis(4-methylphenol), 5-methoxyresorcinol, 2,2′-methylene-bis[6-(2-hydroxy-5-methylbenzyl)-p-cresol, 4,4′-methylene-bis(2-methylphenol), methyl 2,4-dihydroxyaminobenzoate, 2,2′-methylene-bis(6-cyclohexyl-p-cresol), methyl 3,4-dihydroxyaminobenzoate, and 2,5-dihydroxyaminobenzoate, 2,2′,4,4′-tetrahydroxybenzophenone, 2,4,4′-trihydroxybenzophenone, 5-methylpyrogallol, 2′,4′,6′-trihydroxypropiophenone, 2,3,4-trihydroxybenzophenone, 2′,3′,4′-trihydroxyacetophenone, 1,1,1-tris(4-hydroxyphenol)ethane, 2,3′,4,4′-tetrahydroxybenzophenone, 4,4′,4″-trihydroxytriphenylmethane, 2,3,4,4′-tetrahydroxybenzophenone, 2,3,4,4′-tetrahydroxydiphenylmethane, 5,5′,6,6′-tetrahydroxy-3,3,3′,3′-tetramethyl-1,1′-spirobiindane, 2,4,5-trihydroxybenzaldehyde, 6,6′,7,7′-tetrahydroxy-4,4,4′4′-tetramethylspirobicromane, tetrafluoro-hydroquinone, 2,3,4-trihydroxybenzaldehyde, 2,2-bis(4-hydroxyphenyl)propane, 2,2-bis(4-hydroxyphenyl)hexafluoropropane, 2,2-bis(2-hydroxy-5-biphenyl)propane, 2,2-bis(3-cyclohexyl-4-hydroxyphenyl)propane, 2,2-bis(3-sec-butyl-4-hydroxyphenyl)propane, 2,2-bis(4-hydroxy-3,5-dimethylphenyl)propane, 2,2-bis(4-hydroxy-3-isopropylphenyl)propane, 2,2-bis(4-hydroxy-3-methylphenyl)propane, and the like.

Other cross-linkers include boron trihalide amine adducts of amines such as monoethanolamine, diethylamine, dioctylmethylamine, triethylamine, pyridine, benzylamine, benzyldimethyl amine, and the like. Additional cross-linkers include phosphine compounds, such as tributylphosphine, triphenylphosphine, tris(dimethoxyphenyl)phosphine, tris(hydroxypropyl)phosphine and tris(cyanoethyl)phosphine; phosphonium salts, such as tetraphenylphosphonium tetraphenylborate, methyltributylphosphonium tetraphenylborate and methyltricyanoethyl phosphonium tetraphenylborate; and the like.

In an embodiment, secondary intumescent precursor 20 includes the acid source. Without wishing to be bound by theory, it is believed that the acid source is a dehydrating agent such as, e.g., an acid or the salt of an acid that interacts with primary intumescent precursor 8 in intumescent coating 4 when article 2 is subjected to heating. The acid source includes a Brønsted-Lowry acid, Lewis acid, or a combination thereof. In an embodiment, the acid source is introduced in a form such as an ester or salt that decomposes in response to heating to produce acidic residues. The acid source, includes borates, sulfates, sulfites, nitrates, phosphates, phosphonates, melamines, and the like.

In an embodiment, the acid source is an oxy-acid that includes phosphoric acid, metaphosphoric acid, orthophosphoric acid, pyrophosphoric acid, polyphosphoric acid, sulfuric acid, and salts thereof. The acid source can be present, e.g., as an ammonium, amine, or amide salt of these acids.

Exemplary acid sources further include alkyl diphenyl phosphates; trimethyl phosphate (C₃H₉O₄P); triphenylphosphine oxide (C₁₈H₁₅OP); triphenyl phosphate (C₁₈H₁₅O₄P);

ammonium phosphates such as monoammonium phosphate (NH₄H₂PO₄), diammonium phosphate (NH₄)₂HPO₄, ammonium polyphosphate (NH₄PO₃)ₙ, and the like;

amine phosphates such as melamine phosphates, e.g., melamine orthophosphate (C₃H₆N₆H₃O₄P), dimelamine orthophosphate (2C₃H₆N₆H₃O₄P), melamine pyrophosphate (2C₃H₆N₆H₄O₂P₂), and the like;

trialkyl phosphates such as triethyl phosphate (C₆H₁₅O₄P), trioctyl phosphate (C₂₄H₅₁O₄P), dimethyl methylphosphonate, (C₃H₉O₃P), diethyl ethylphosphonate, (C₆H₁₅O₃P), and the like;

halogenated alkyl phosphates and phosphonates such as tris(2-chloroethyl) phosphate (C₆H₁₂Cl₃O₄P), tris(1-chloro-2-propyl) phosphate (C₉H₁₈Cl₃O₄P), tris(1,3-dichloro-2 propyl) phosphate (C₉H₁₅Cl₆O₄P), tris[3-bromo-2,2-bis(bromomethyl)propyl]phosphate (C₁₅H₂₄Br₉O₄P), bis(2-chloroethyl)-2-chloroethyl phosphonate, and the like;

diphosphates such as 2-chloroethyl diphosphates, e.g., tetrakis(2-chloroethyl), ethylene oxyethylene diphosphate (C₁₂H₂₄Cl₄O₉P₂), C₁₃H₂₄Cl₆O₈P₂ (available under trade name Antiblaze 100), 2-chloroethyl 2-bromoethyl 3-bromoneopental phosphate (C₉H₁₈Br₂ClO₄P) (available under trade name Firemaster 836);

cyclic phosphonates such as C₁₅H₃₁O₉P₃ (available under trade name Antiblaze 19 or 1045), cyclic neopentyl thiophosphoric anhydride, and the like;

aryl phosphates such as cresyl diphenyl phosphate, (C₁₉H₁₇O₄P) and the like;

triaryl phosphates such as triphenyl phosphate (C₁₈H₁₅O₄P), tetraphenyl resorcinol diphosphate (C₃₈H₂₄O₈P), tris(2,4-dibromophenyl) phosphate (C₁₈H₉Br₆O₄P), and the like;

diphosphine oxides (available under trade names such as Cyagard RF1204 American Cyanamid); and the like.

According to an embodiment, the acid source is a bicyclic organophosphorus compound. Exemplary bicyclic organophosphorus compounds include pentaerythritol phosphite, trimethylolpropane phosphite, trimethylolethane phosphite, trimethylolbutane phosphite, trimethylol isobutene phosphite, trimethylol pentane phosphite, trimethylolhexane phosphite, trimethylolheptane phosphite, trimethylol octane phosphite, trimethylolnonane phosphite, trimethylolundecane phosphite, trimethylolheptadecane phosphite, pentaerythritol phosphate, pentaerythritol thiophosphate, pentaerythritol selenophosphate, trimethylolpropane phosphate, trimethylolpropane thiophosphate, trimethylol propane selenophosphate, trimethylolethane phosphate, trimethylolethane thiophosphate, trimethylolethane selenophosphate, trimethylolbutane phosphate, trimethylol butane thiophosphate, trimethylolpentane phosphate, trimethylolpentane thiophosphate, trimethylolpentane selenophosphate, trimethylolhexane phosphate, trimethylolhexane thiophosphate, trimethylolheptane phosphate, trimethylolheptane thiophosphate, trimethyloloctane phosphate, trimethyloloctane thiophosphate, trimethylolnonane phosphate, trimethylolnonane thiophosphate, trimethylolnonane selenophosphate, trimethyloldecane phosphate, trimethyloldecane thiophosphate, trimethylolundecane phosphate, trimethylolundecane thiophosphate, trimethylolheptadecane phosphate, trimethylolheptadecane thiophosphate, trimethylolheptadecane selenophosphate, and the like.

In an embodiment, the acid source is pentaerythritol phosphate alcohol, which is sometimes referred to as pentaerythritol phosphate. Derivatives of the bicyclic phosphorus compounds are contemplated, e.g., esters, ethers, or carbonates of pentaerythritol phosphate alcohol.

According to an embodiment, intumescent coating 4 includes layered material 10 and a primary intumescent precursor 8. Layered material 10 includes the layered double hydroxide, silicate mineral, or a combination thereof.

Layered double hydroxides include a naturally occurring or synthetic compound based on the mineral brucite Mg(OH)₂ and have a crystal structure with a plurality of positively charged layers with a combination of metal hydroxides between which are a plurality of anions or water molecules. Hydrotalcite is a naturally occurring layered double hydroxide wherein carbonate is present as the anion. Meixnerite is a layered double hydroxide wherein hydroxyl is present as the anion.

In the layered double hydroxide, brucite-like layers include octahedra alternating with interlayers that contain water and charge-balancing anions, which compensate for electrostatic charge deficiencies of crystalline clay sheets of the layered double hydroxide. Exemplary anions include NO₃⁻, OH⁻, Cl⁻, Br⁻, I⁻, SO₄²⁻, SiO₃²⁻, CrO₄²⁻, BO₃²⁻, MnO₄⁻, HGaO₃²⁻, HVO4²⁻, ClO₄⁻, BO₃²⁻, pillaring anions such as polyoxometalate anions (e.g., P₂W₁₈O₆₂⁶⁻, Co₄(H₂O)₂(PW₉O₃₄)₂¹⁰⁻, H₂W₁₂O₄₀⁶⁻, V₁₀O₂₈⁶⁻ and Mo₇O₂₄⁶⁻, and the like), monocarboxylates such as acetate, dicarboxylates such as oxalate, alkyl sulfonates such as lauryl sulfonate, and the like.

In an embodiment, the layered double hydroxide is a compound with a formula as follows:

[M(II)ₘ²⁺M(III)ₙ³⁺(OH)₂ₘ₊₂ₙ](X_{n/z}^{z-}).bH₂O,

wherein M(II) is a divalent metal; M(III) is a trivalent metal; X^{z-} is the charge-balancing anion; b has a value from ½ to 10; and m and n have a value such that a ratio of m to n is from 1 to 6, specifically from 2 to 4, and more specifically 3. Exemplary layered double hydroxides include Mg₆Al₂CO₃(OH)₁₆.4H₂O, Ni₆Al₂CO₃(OH)₁₆.4H₂O, Ni₃Mg₃Al₂CO₃(OH)₁₆.4H₂O, Co₃Mg₃Al₂CO₃(OH)₁₆.4H₂O, Co₆Al₂CO₃(OH)₁₆.4H₂O, Ni_{0.90}Co_{0.75}Cu_{0.35}Mg₄Al₂CO₃(OH)₁₆.4H₂O, Cu₃Mg₃Al₂CO₃(OH)₁₆.4H₂O Cu₆Al₂CO₃(OH)₁₆.4H₂O, Cu₃Zn₃Al₂CO₃(OH)₁₆.4H₂O, Ni₃Zn₃Al₂CO₃(OH)₁₆.4H₂O, Ni3Mg3Al_{1.8}Cr_{0.2}CO₃(OH)₁₆.4H₂O, and the like.

Forming layered double hydroxides has been described, e.g., Cavani et al., Hydrotalcite-Type Anionic Clays, Catalysis Today 11, 173 (1991) and Besse et al., Anionic clays, in Synthesis and Microporous Materials (1992), 108 (Van Nostrand Reinhold, 1992), the entire disclosure of each of which is incorporated herein by reference.

Exemplary layered double hydroxides include naturally occurring minerals from the hydrotalcite supergroup such as barbertonite, brugnatellite, caresite, carrboydite, charmarite, chlormagaluminite, coalingite, comblainite, cualstibite, cyanophyllite, desautelsite, droninoite, fougerite, glaucocerinite, honessite, hydrocalumite, hydrohonessite, hydrotalcite, hydrowoodwardite, iowaite, jamborite, karchevskyite, kuzelite, manasseite, meixnerite, motukoreaite, mountkeithite, muskoxite, natroglaucocerinite, nikischerite, pyroaurite, quintinite, reevesite, shigaite, sjögrenite, stichtite, takovite, wermlandite, woodallite, woodwardite, zaccagnaite, zincalstibite, zincaluminite, zincowoodwardite, and the like. According to an embodiment, the layered double hydroxide is hydrotalcite.

In an embodiment, the layered material is the silicate mineral. The silicate mineral includes a cyclosilicate, inosilicate, nesosilicate, phyllosilicate, sorosilicate, tectosilicate, or a combination thereof.

Cyclosilicates are silicates with tetrahedrons that can link to form rings of three (Si₃O₉)⁻⁶, four (Si₄O₁₂)⁻⁸, six (Si₆O₁₈)⁻¹² or nine (Si₉O₂₇)⁻¹⁸ units. Exemplary cyclosilicates include benitoite, axinite, beryl, cordierite, tourmaline, papagoite, eudialyte, milarite, and the like.

The inosilicate can have a crystalline structure in the form of a chain such as pyroxenes and pyroxenoids (with a crystalline structure of single chains (SiO₃)⁻²) or amphiboles (with a crystalline structure of double chains (Si₄O₁₁)⁻⁶). Non-limiting examples of pyroxenes and pyroxenoids include diopside, spodumene, wollastonite, enstatite, hypersthene, hedenbergite, augite, pectolite, diallage, fassaite, spodumene, jeffersonite, aegirine, omphafacite, hiddenite, and the like. Non-limiting examples of amphiboles are calcium amphiboles such as tremolite, actinote, and hornblende; iron-magnesium amphiboles such as grunerite and cummingtonite; and sodium amphiboles such as glaucophane, arfvedsonite, riebeckite; and the like.

Non-limiting examples of nesosilicates are alite, almandine, andalousite, andalusite, andradite, belite, chloritoid, chondrodite, clinohumite, datolite, dumortierite, fayalite, forsterite, grossular, humite, hydrogrossular, kyanite, norbergite, olivine, phenakite, pyrope, sillimanite, spessartine, staurolite, thaumasite, thorite, titanite, topaz, uvarovite, zircon, and the like.

The phyllosilicate includes sheet silicates having substantially parallel sheets of silicate tetrahedra with Si₂O₅ in a 2:5 ratio such as a clay, mica, serpentine, chlorite, or a combination thereof. Exemplary phyllosicates include akermatite, aliettite, allophane, aluminoceladonite, amesite, anandite, annite, antigorite, apophyllite, aspidolite, baileychlore, batavite, beidellite, bementite, bensonite, bentonite, berthierine, biotite, bismutoferrite, bityite, boromuscovite, borocookeite, bowlingite, brammalite, brindleyite, bronrobersite, brokenhillite, burckhardtite, caryopilite, cavansite, celadonite, chamosite, champmanite, chernykhite, chlorite, chlorite group, chromceladonite, chromphyllite, chrysocolle, chrysolite; chrysotile, clay mineral group, clinochlore, clintonite, cookeite, corrensite, cronstedtite, damouzite, delessite, dickite; donbassite, dozyite, eastonite, eirikite, ephesite, falcondoite, fedorite, ferripyrophyllite, ferrisurite, ferroaluminoceladonite, ferroceladonite, ferrokinoshitalite, ferrosaponite, fireclay, fluorannite, fluorophogopite, fraipontite, franklinfurnaceite, friedelite, fuchsite, ganterite, garnierite, gehlenite, glagolevite, glauconite, gonyerite, greenalite, grumantite, gyrolite, halloysite, hectorite, hendricksite, hisingerite, hydrobiotite, illite, imogolite, intersilite, kalifersite, kaolinite, karpinskite, kegelite, kellyite, kinoshitalite, kulkeite, kurumsakite, lalondeite, ledikite, leifite, lepidolite, lizardite, loughlinite, lunijianlaite, macaulayite, makatite, manandonite, manganoneptunite, margarite, martinite, masutomilite, magillite, medicinal clay, melilite, mica group, mica, minehillite, minnesotaite, montdorite, montmorillonite, muscovite, nacrite, nafersite, nanpingite, natrosilite, nelenite, neotocite, nepouite, niksergievite, nimite, nontronite, norrishite, odinite, okenite, orlymanite, orthochamosite, oxykinoshitalite, palygorskite (attapulgite), paragonite, pecoraite, pennantite, petalite, phlogite, phlogopite, polylithionite, preiswerkite, pyrophyllite, pyrosmalite-(fe), pyrosmalite-(mn), raite, rectorite, reyerite, roscoelite, saliotite, saponite, sarcolite, sauconite, schallerite, sepiolite, sericite, serpentine, serpentine group, shafranovskite, shirokshinite, shirozulite, siderophyllite, smectite, sokolovaite, spadaite, stevensite, stilpnomelane, sudoite, suhailite, surite, swinefordite, tainiolite, talc, telyushenkoite, tetraferripholgopite, tetraferriannite, tobelite, tosudite, trilithionite, tupperssuatsiaite, tungusite, truscottite, ussingite, varennesite, vermiculite, volkhonskoite, watatsumiite, willemseite, wonesite, yakhontovite, yofortierite, zakharovite, zeophyllite, zincsilite, zinnwaldite, and the like.

The sorosilicate can be allanite, clinozoisite, dollaseite, epidote, hemimorphite, ilvaite, lawsonite, prehnite, tanzanite, vesuvianite, zoisite, and the like.

The tectosilicate can be, for example, albite, alkali-feldspars, analcime, andesine, anorthite, anorthoclase, bytownite, cancrinite, celsiane, chabazite, coesite, cristobalite, feldspar, feldspathoid, hauyne, heulandite, labradorite, lazurite, leucite, marialite, meionite, microcline, mordenite, natrolite, nepheline, nosean, oligoclase, orthoclase, petalite, plagioclase, quartz, sanidine, scapolite, scolecite, silica, sodalite, stilbite, tridymite, zeolite, and the like.

Exemplary zeolites include naturally occurring zeolites such as amicite, analcime, barrerite, bellbergite, bikitaite, boggsite, brewsterite, chabazite, clinoptilolite, cowlesite, dachiardite, edingtonite, epistilbite, erionite, faujasite, ferrierite, garronite, gismondine, gmelinite, gobbinsite, gonnardite, goosecreekite, harmotome, herschelite, heulandite, laumontite, levyne, maricopaite, mazzite, merlinoite, mesolite, montesommaite, mordenite, natrolite, offretite, paranatrolitem, paulingite, pentasil, perlialite, phillipsite, pollucite, scolecite, sodium dachiardite, stellerite, stilbite, tetranatrolite, thomsonite, tschernichite, wairakite, wellsite, willhendersonite, and yugawaralite. In some embodiments, the zeolite is analcime, chabazite, clinoptilolite, heulandite, natrolite, phillipsite, stilbite, or a combination thereof. A synthetic zeolite also can be used as the tectosilicate of the silicate mineral. The synthetic zeolites can be selected from Zeolite A, Zeolite B, Zeolite F, Zeolite H, Zeolite L, Zeolite T, Zeolite W, Zeolite X, Zeolite Y, Zeolite Omega, Zeolite ZSM-5, Zeolite ZSM-4, Zeolite P, Zeolite N, Zeolite D, Zeolite O, Zeolite S, and Zeolite Z.

In an embodiment, the silicate mineral can include other elements or components in addition to silicon and oxygen. The silicate mineral can include an oxide, for example, silicon dioxide (Sift), aluminum oxide (Al₂O₃), barium oxide (BaO), bismuth trioxide (Bi₂O₃), boron oxide (B₂O₃), calcium oxide (CaO), cesium oxide (CsO), lead oxide (PbO), strontium oxide (SrO), rare earth oxides (e.g., lanthanum oxide (La₂O₃), neodymium oxide (Nd₂O₃), samarium oxide (Sm₂O₃), cerium oxide (CeO₂)), and the like. An exemplary silicate mineral containing SiO₂ includes quartz, cristobalite, tridymite, and the like. The other elements can be, for example, aluminum, antimony, arsenic, barium, beryllium, boron, calcium, cerium, cesium, chromium, cobalt, copper, gallium, gold, iron, lanthanum, lead, lithium, magnesium, manganese, molybdenum, neodymium, nickel, niobium, palladium, phosphorus, platinum, potassium, praseodymium, silver, sodium, tantalum, thorium, titanium, vanadium, zinc, zirconium, and the like. The other elements can occur in the silicate mineral in the form of oxides, carbonates, nitrates, phosphates, sulfates, or halides. Furthermore, the other element can be a dopant in the silicate mineral.

It is contemplated that the silicate mineral is functionalized to include a polar group to form a functionalized silicate mineral. Functionalization can be achieved by a cation exchange reaction, substitution, condensation, alkoxysilane chemistry, and the like. Without wishing to be bound by the theory, the silicate mineral can have a functional group such as hydroxyl, amino, sulfate, phosphate, nitrate, carbonyl, carboxyl, imino, and the like on its surface to interact with primary intumescent precursor 8, secondary intumescent precursor 20, the additive, and the like.

According to an embodiment, the silicate mineral is a phyllosilicate. In a particular embodiment, the silicate mineral is montmorillonite.

In an embodiment, intumescent coating 4 includes the additive, which includes, e.g., a plurality of nanotubes, nanofibers, nanoparticles, glass particles, ceramic particles, a boron source or a combination thereof. The glass particles can include a glass recited above for substrate 6. The ceramic particles can include a ceramic recited above for substrate 6.

In an embodiment, the additive is the boron source. The boron source can be boric acid, a salt of boric acid, a salt of a hydrate of boric acid that includes sodium, potassium, lithium, and the like. Varying degrees of hydration are contemplated.

Exemplary boron sources include a sodium tetraborate decahydrate, sodium tetraborate pentahydrate, sodium octaborate tetrahydrate, sodium metaborate, sodium perborate hydrate, disodium octaborate tetrahydrate, potassium tetraborate, sodium pentaborate, ammonium pentaborate hydrate, hydrasodium tetraborate, potassium metaborate, alkali metal borate salt, octaborate tetrahydrate (e.g., Na₂B₈O₁₃,4H₂O, commercially available from IMC Chemical), metal borate compounds such as calcium borate, borate silicate, aluminum silicate borate hydroxide, silicate borate hydroxide fluoride, hydroxide silicate borate, sodium silicate borate, calcium silicate borate, aluminum borate, boron oxide, magnesium borate, iron borate, copper borate, zinc borate, sodium polyborate, and the like.

Sparingly soluble boron sources include minerals such as probertite, ulexite, nobleite, gowerite, frolovite, colemanite, meyerhofferite, inyoite, priceite, tertschite, ginorite, pinnoite, paternoite, kurnakovite, inderite, preobazhenskite, hydroboracite, inderborite, kaliborite (heintzite), vealchite, and the like.

It is contemplated that the boron source has a high heat activation temperature such that a high temperatures is required to convert the boron source into an acidic form.

Article 2 includes intumescent coating 4 that is a product of disposing, on substrate 6, a composition that includes primary intumescent precursor 8 and layered material 10 such that layered material 10 is dispersed among first intumescent precursor 8 in intumescent coating 4. In an embodiment, the composition is a liquid. Accordingly, the primary intumescent precursor 8, layered material 10, secondary intumescent precursor 20, or additive can be disposed in a solvent to create the liquid composition.

In an embodiment, a composition to form intumescent coating 4 on substrate 6 includes the solvent, primary intumescent precursor 8 to contact substrate 6 and to form intumescent coating 4 on substrate 6, and layered material 10 disposed in the solvent. Primary intumescent precursor 8 includes the carbohydrate polymer. Layered material 10 will be dispersed among primary intumescent precursor 8 in intumescent coating 4 and includes the silicate mineral, layered double hydroxide, or a combination thereof.

According to an embodiment, the composition further includes secondary intumescent precursor 20 to combine with primary intumescent precursor 8 to form intumescent coating 4 on substrate 6. In certain embodiments, the composition includes substrate 6 disposed in the solvent. It is contemplated that substrate 6 is substantially insoluble in the solvent.

According to an embodiment, the composition includes a solvent. The solvent can be selected so that the first intumescent precursor, second intumescent precursor, additive, or layered material have appreciable solubility, can be dispersed in the solvent, or is selected to control the available amount of the first intumescent precursor, second intumescent precursor, additive, or layered material in the solvent for forming the intumescent coating. In this regard, the solvent is a polar solvent (e.g., an aqueous solvent) or a nonpolar solvent. For a first intumescent precursor, second intumescent precursor, additive, layered material, or substrate that is hydrophobic, a polar solvent can be included in the composition so that the hydrophobic species is available to be disposed on the substrate.

The solvent may include polar protic solvents, polar aprotic solvents, or a combination comprising at least one of these. The solvent may include an electrolyte in the form of a salt, or a pH adjustment agent (e.g., by addition of acid or base), or a buffering agent.

An aqueous solvent is, e.g., water, and organic solvents include an alcohol (e.g., methanol, ethanol, isopropanol, and the like), dimethylsulfone, acetone, an acetate, dimethsulfoxide, dimethylformamide, γ-butyrolactone, tetrahydrofuran, propylene carbonate, ethylene glycol, an ether, an aromatic solvent (e.g., benzene, toluene, p-xylene, ethylbenzene, and the like), or a combination comprising at least one of the foregoing.

Exemplary solvents thus include water including buffered or pH adjusted water; alcohols, such as methanol, ethanol, propanol, isopropanol, butanol, t-butanol, octanol, cyclohexanol, ethylene glycol, ethylene glycol methyl ether, ethylene glycol ethyl ether, ethylene glycol butyl ether, propylene glycol, propylene glycol methyl ether, propylene glycol ethyl ether, diethylene glycol, triethylene glycol, dipropylene glycol, tripropylene glycol, cyclohexanol, and the like; polar aprotic solvents such as dimethylsulfoxide, sulfolane, ethylene carbonate, propylene carbonate, N,N-dimethylformamide, N,N-dimethylacetamide, N-methylpyrrolidone, gamma butyrolactone, and the like; or a combination comprising at least one of the foregoing solvents.

In an embodiment, the solvent is an alcohol, including a primary alcohol, a secondary alcohol, or a tertiary alcohol. Exemplary alcohols include methanol, ethanol, (n- or iso-) propanol, (n-, sec-, i-, or t-) butanol, pentanol, octanol, cyclohexanol, benzyl alcohol, furfuryl alcohol, and the like. According to an embodiment, the solvent is ethylene glycol or a homolog thereof (e.g., diethylene glycol, triethylene glycol, and the like), propylene glycol or a homolog thereof (e.g., dipropylene glycol, tripropylene glycol, and the like), glycerol or an ether thereof, an ethylene or propylene glycol monoether (e.g., ethylene glycol methyl ether, ethylene glycol ethyl ether, ethylene glycol butyl ether, propylene glycol methyl ether, propylene glycol ethyl ether, and the like), and the like. In some embodiments, the solvent is a combination of a cellosolve or a carbitol with another polar solvent, e.g., N-methylpyrrolidone, dimethylformamide, dimethylacetamide, dimethylsulfoxide, pyridine, ethylene or propylene glycol or their higher homologs, glycerol, and the like.

Exemplary polar aprotic solvents include dimethylsulfoxide; sulfolane; ethylene carbonate; propylene carbonate; N,N-dimethylformamide; N,N-dimethylacetamide; N-methylpyrrolidone; dimethylsulfoxide; gamma butyrolactone; pyridine or a derivative thereof, an N-substituted (e.g., methyl-, ethyl-, formyl-, or acetyl-derivatized) pyrrole, pyrrolidone, piperidine, morpholine, and the like; and the like.

In an embodiment, the solvent is an amine, including a primary amine, secondary amine, or tertiary amine or an amine with a plurality of amino groups. Exemplary amines include hexadecyltrimethylammonium hydroxide, n-tetrabutylammonium hydroxide, tetraethylammonium hydroxide, tetramethylammonium hydroxide, tetrakis(decyl)ammonium hydroxide, dimethylethanol amine, triethanol amine, N-tert-Butyldiethanol amine. Exemplary alkylamines include ethyl amine, n-butylamine, t-butyl amine, n-hexylamine, n-decylamine, diethylamine, di(n-propylamine), di(iso-propyl amine), trimethylamine, triethylamine, tri(n-butylamine), tetramethyl ethylenediamine, dimethyl ethylenediamine, ethylenediamine, bis(hexamethylene)triamine, N,N′,N″-trimethylbis(hexamethylene)triamine, and the like.

Exemplary nonaqueous solvents include an aliphatic hydrocarbon (hexane, heptane, 2,2,4-trimethylpentane, n-octane, cyclohexane), an alcohol (e.g., 2-methoxyethanol, butanol, phenol, and the like), an aldehyde (e.g., acetaldehyde, n-butyraldehyde, crotonaldehyde, 2-ethylhexyldehyde, isobutylaldehyde, propionaldehyde, and the like), an amine (e.g., triethylamine, trimethanol amine, and the like), a nitrogen-containing polar solvent (e.g., N,N-dimethylformamide, nitromethane, N-methylpyrrolidone, and the like), a sulfur compound (e.g., dimethyl sulfoxide), an aromatic hydrocarbon (e.g., benzene, toluene, xylene, and the like), a carbonic acid ester (e.g., tetrachloroethylene carbonate, dichloroethylene carbonate, and the like), a carboxylic acid (e.g., acetic acid, propionic acid, and the like), an ester (e.g., methyl acetate, ethyl acetate, isopropyl acetate, n-propyl acetate, isobutyl acetate, n-butyl acetate, isobutyl isobutyrate, 2-ethylhexyl acetate, ethylene glycol diacetate, and the like), an ether (e.g., dimethyl ether, dioxane, tetrahydrofuran, methyl cellosolve, and the like), an ether alcohol (e.g., ethoxy ethanol, methoxy ethoxy ethanol, and the like), an ether ester (e.g., ethyl 3-ethoxypropionate and the like), a glycol ether ester (e.g., propylene glycol monomethyl ether acetate, ethylene glycol monoethyl ether acetate, ethylene glycol monobutyl ether acetate, diethylene glycol monobutyl ether acetate, and the like), a halogenated hydrocarbon (e.g., methylene chloride, chloroform, carbon tetrachloride, chlorobenzene, 1,1,1-trichloroethane, benzoyl fluoride, benzoyl chloride, and the like), a ketone (e.g., acetone, cyclohexanone, acetophenone, 4-hydroxy-4-methyl-2-pentanone, methyl ethyl ketone, methyl isobutyl ketone, methyl isoamyl ketone, methyl n-amyl ketone, diisobutyl ketone, cyclohexanone, isophorone, and the like), a phthalate (e.g., dibutyl phthalate, diethyl phthalate, dimethyl phthalate, dioctyl phthalate, dioctyl terephthalate, butyl octyl phthalate, butyl benzyl phthalate, alkyl benzyl phthalate, and the like), an oil (e.g., mineral oil, silicone oil, and the like), and the like.

Further exemplary nonaqueous solvents include nitromethane, nitrobenzene, acetic anhydride, phosphorus oxychloride, benzonitrile, tetramethylsulfone, dioxane, 1,2-propanediol carbonate, benzyl cyanide, ethylene sulfite, isobutyronitrile, propionitrile, dimethyl carbonate, propylene carbonate, ethyl methyl carbonate, ethylene carbonate, phenyl phosphoric acid difluoride, n-butyronitrile, phenyl phosphoric acid dichloride, diphenyl phosphoric acid chloride, trimethyl phosphate, tributyl phosphate, hexamethylphosphoric amide, diglyme, polybenzimidazole, and the like.

These solvents can be used alone or combination. Further, the solvent can be substituted with a functional group (e.g., an alkyl group, alkenyl group, alkynyl group, or a functional as recited below for the nanoparticles).

In some embodiments the solvents is an aqueous solvent. In other embodiments, the solvent is a nonaqueous solvent. In yet other embodiments, the solvent includes a plurality of water miscible compounds and optionally water such that the solvent includes water in an amount less than or equal to 100 wt %, specifically less than or equal to 80 wt %, more specifically less than or equal to 50 wt %, further specifically less than or equal to 25 wt %, yet more specifically less than or equal to 10 wt %, or further more specifically less than or equal to 1 wt %, based on a total weight of the solvent. In some embodiments, the solvent contains no water, or water is substantially absent from the solvent.

In an embodiment, the composition also includes a pH control agent disposed in the solvent. Exemplary pH control agents include an acid (e.g., a mineral acid, organic acid, and the like), base (e.g., strong base or weak base), buffer, and the like.

In an embodiment, first intumescent precursor 8 is present in intumescent coating 4 in an amount from 1 weight percent (wt %) to 90 wt %, specifically from 1 wt % to 70 wt %, more specifically from 1 wt % to 50 wt %, based on a weight of intumescent coating 4 when dry, e.g., in an absence of solvent. In an embodiment, layered material 10 is present in intumescent coating 4 in an amount from 2 weight percent (wt %) to 99 wt %, specifically from 20 wt % to 90 wt %, more specifically from 30 wt % to 80 wt %, based on a weight of intumescent coating 4 when dry, e.g., in an absence of solvent. In an embodiment, second intumescent precursor 20 is present in intumescent coating 4 in an amount from 0 weight percent (wt %) to 90 wt %, specifically from 1 wt % to 80 wt %, more specifically from 1 wt % to 70 wt %, based on a weight of intumescent coating 4 when dry, e.g., in an absence of solvent. In an embodiment, the additive is present in intumescent coating for in an amount from 0 weight percent (wt %) to 60 wt %, specifically from 0.05 wt % to 40 wt %, more specifically from 0.5 wt % to 30 wt %, based on a weight of intumescent coating 4 when dry, e.g., in an absence of solvent.

In the composition, a total amount of primary intumescent precursor 8 can be from 1 wt % to 90 wt %, specifically 1 wt % to 70 wt %, and more specifically 1 wt % to 50 wt %, based on a weight of the composition. Secondary intumescent precursor 20 can be present in the composition in an amount from 1 wt % to 90 wt %, specifically 1 wt % to 80 wt %, and more specifically 1 wt % to 70 wt %, based on the weight of the composition. The additive can be present in the composition in an amount from 0.05 wt % to 60 wt %, specifically 0.5 wt % to 40 wt %, and more specifically 0.5 wt % to 30 wt %, based on the weight of the composition. The layered material can be present in the composition in an amount from 2 wt % to 99 wt %, specifically 20 wt % to 90 wt %, and more specifically 30 wt % to 80 wt %, based on the weight of the composition. In a particular embodiment, a weight ratio of primary intumescent precursor 8 to secondary intumescent precursor 20 is from 1:1 to 100:1, specifically 1:1 to 50:1, and more specifically 1:1 to 10:1. In some embodiment, intumescent coating includes primary intumescent precursor 8 and none or substantially no secondary intumescent precursor 20.

Article 2 can be formed in numerous ways. According to an embodiment, a process for forming article 2 includes forming a liquid composition by disposing, in a solvent, primary intumescent precursor 8 that includes a carbohydrate polymer and also disposing, in the solvent, layered material 10 that includes a silicate mineral, a layered double hydroxide, or a combination thereof. The process also includes contacting substrate 6 with the liquid composition and forming intumescent coating 4 on substrate 6 to form article 2.

The process further includes adjusting a pH of the solvent, a temperature of the solvent, or a combination thereof. In some embodiments, adjusting the pH of the solvent includes adding an acid, base, or buffer to the solvent. According to an embodiment, the process also includes treating substrate 6 with an acid solution (e.g., dilute HNO3) prior to contacting substrate 6 with primary intumescent precursor 8 and layered material 10.

Substrate 6 may be untreated or may be surface-treated prior to disposing intumescent coating 4 on substrate 6, e.g., before contacting substrate 6 with the composition. Surface-treating of substrate 6 may be effected by corona treatment, plasma treatment, chemical vapor treatment, wet etch, ashing, primer treatment including polymer based primer treatment or organosilane treatment, and the like. In an embodiment, a surface of substrate 6 is treated by corona treatment prior to contacting substrate 6 with the composition. In another embodiment, the surface of substrate 6 is pre-treated by applying a polymer-based primer layer prior to contacting substrate 6 with the composition. An exemplary primer includes those manufactured by Lord Adhesives and marketed under the trade name CHEMLOK. In another embodiment, the surface of substrate 6 may be pretreated by dipping substrate 6 in an organosilane primer to form a primer layer prior to contacting substrate 6 with the composition. Such pretreatments serve to enhance the adhesion and bonding between substrate 6 and intumescent coating 4.

In an embodiment, contacting substrate 6 with the composition includes submerging substrate 6 in the composition. Contacting substrate 6 with the composition includes immersing substrate 6, submersing substrate 6, film casting, spin casting, dip coating, spray coating, brush coating, roll coating, and the like. Such methods can form intumescent coating 4 disposed on substrate 6.

It will further be appreciated that the components of intumescent coating 4 can undergo chemical interaction or transformation to form another material, particularly during heating article 2. As such, embodiments include components of article 2 whether or not a chemical interaction or transformation occurs. That is, embodiments include compositions and article 2 of the recited compositions as well as reaction products thereof.

Intumescent coating 4, article 2, and methods described have beneficial and advantageous properties such as imparting fire retardancy to substrate 6, improving chemical or physical change resiliency to substrate 6, increasing explosive decompression resistance, strength, toughness, wear resistance, thermal resistance, heat/electrical conductivity, and the like to substrate 6 found in a wide variety, e.g., of consumer goods. Intumescent coating 4, while serving as a fire barrier on substrate 6, allows for substrate 6 and articles 2 made therefrom to maintain the physical properties of substrate 6 such as fluid permeability, flexibility, hardness, tensile strength, glass transition temperature, and the like. Advantageously, disposing primary intumescent precursor 8, layered material 10, and optionally secondary intumescent precursor 20 on substrate 6 to form intumescent coating 4 occurs in a single step of contacting substrate 6 with the fluid composition. Accordingly, the process of forming intumescent coating 4 on substrate 6 is fast, reliable, and time efficient. It is contemplated that the coating process can be repeated a plurality of times to form a plurality of substantially identical or different intumescent coatings 4 on substrate 6. Moreover, the coating technique used to dispose intumescent coating 4 on substrate 6 can impart varying thickness intumescent coating 4, based on the desired application of substrate 6. Even further, intumescent coating 4 can be applied as a film so thin that a size tolerance of article 4 based on a size dimension of substrate 6 is not affected by a presence of intumescent coating 6, while being thick enough to impart properties described above on the substrate 6.

In an embodiment, intumescent coating 4 and process of forming intumescent coating 4 beneficially comports with accepted principles of green chemistry as published by Anastas and Warner, Green Chemistry: Theory and Practice (Oxford University Press: New York, 1998), the disclosure of which is incorporated herein in its entirety. Intumescent coating 4 and process of forming intumescent coating 4 reduce or eliminate a use or generation of hazardous substances and is applicable across a life cycle of article 2, including its design, manufacture, and use.

Additionally, intumescent coating 4 includes a carbon source, a blowing agent, an acid source, or combination thereof that comports with green chemistry principles. In an embodiment, primary intumescent precursor 8 and secondary intumescent precursor 20 are independently a carbon source, a blowing agent, an acid source, or a combination thereof.

It is contemplated that article 2 has fire retardant properties and is configured to be subjected to a variety of conditions (e.g., test conditions or conditions while article 2 is in use) that include an ignition source, e.g., a flame source (e.g., a candle), smoldering source (e.g., a cigarette, specifically NIST Standard Reference Material 1196), hot-wire, hot-current, electrical arc, high heat (e.g., an electrical heater), and the like.

Moreover, article 2 has fire retardant properties that include a maximum amount of heat released (peak heat release rate, PHRR) that is less than or equal to 300 kilowatts per square meter (kW/m²), specifically less than or equal to 200 kW/m², more specifically less than or equal to 150 kW/m², further specifically less than or equal to 100 kW/m², and even more specifically less than or equal to 50 kW/m²; a total amount of heat released (total heat released, THR) that is less or equal to 120 megajoules per square meter (MJ/m²), specifically less than or equal to 80 MJ/m², more specifically less than or equal to 50 MJ/m², and further specifically less than or equal to 25 MJ/m²; an average amount of heat released (average heat release rate, AHRR) that is less than or equal to 60 kW/m², specifically less than or equal to 40 kW/m², and more specifically less than or equal to 20 kW/m²; a percentage mass loss that is relative to starting mass and that is less than 60%, specifically less than 40%, more specifically less than 20%, further specifically less than 10%, and even more specifically less than 5%, based on a starting mass of article 2; a resistance to ignition (e.g., without an external heat source) is ignition then self-extinguishing of visible flames in less than 60 seconds (sec), specifically self-extinguishing of visible flames in less than 40 sec, more specifically self-extinguishing of flames in less than 20 sec, and even more specifically no ignition of article 2.

Article 2 and substrate 6 have a substantially similar flexibility, fluid permeability, or a combination thereof. A thickness of intumescent coating 4 can be from 1 nm to 1 m, specifically from 1 nm to 5 cm, and more specifically from 10 nm to 100 nm.

Intumescent coating 4 and articles 2 made therewith have advantageous properties. Intumescent coating 4 is a high temperature coating with an advantageous decomposition or flame retardant property. In an embodiment, intumescent coating 4 has a thermal decomposition temperature greater than or equal to 150° C., specifically greater than or equal to 300° C., and more specifically greater than or equal to 500° C. In a certain embodiment, intumescent coating 4 forms an intumescent product from primary intumescent precursor 8 and optionally secondary intumescent precursor 20 at a temperature greater than or equal to 50° C., specifically greater than or equal to 150° C., more specifically greater than equal to 300° C., and further more specifically greater than or equal to 500° C.

The intumescent product formed from primary intumescent precursor 8 and optionally secondary intumescent precursor 20 has a char content greater than or equal to 35 wt %, specifically greater than or equal to 25 wt %, and more specifically greater than or equal to 10 wt %, based on an original weight (before formation of the intumescent product) of intumescent coating 4.

Various terms are used herein. As used herein, “alkenyl” means a linear or branched chain, monovalent hydrocarbon group having at least one carbon-carbon double bond (e.g., ethenyl (—HC═CH₂)).

As used herein, “alkenylene” means a linear or branched chain, divalent hydrocarbon group having at least one carbon-carbon double bond (e.g., ethenylene (—HC═CH—)), optionally substituted with one or more substituents where indicated, provided that the valence of the alkyl group is not exceeded.

As used herein, “alkoxy” means an alkyl group that is linked via an oxygen (i.e., —O-alkyl). Non-limiting examples of C1 to C30 alkoxy groups include methoxy groups, ethoxy groups, propoxy groups, isobutyloxy groups, sec-butyloxy groups, pentyloxy groups, iso-amyloxy groups, and hexyloxy groups.

As used herein, “alkoxyalkyl” means an alkyl radical substituted with one or more alkoxy groups.

As used herein, “alkyl” means a linear or branched chain, saturated, monovalent hydrocarbon group (e.g., methyl or hexyl), optionally substituted with one or more substituents where indicated, provided that the valence of the alkyl group is not exceeded. Alkyl groups include, for example, groups having from 1 to 50 carbon atoms (C1 to C50 alkyl).

As used herein, “C1 to C15 alkylamine group” is a group of the formula Q-N(Rw)(Rz), wherein Q is a C1 to C15 alkenylene, and Rw and Rz are independently hydrogen, a C1 to C14 alkyl, a C1 to C14 alkenyl, a C1 to C14 alkynyl, a C3 to C14 cycloalkyl or a C6 to C14 aryl; such that the total number of carbon atoms in Q, Rw, and Rz is from 1 to 15.

As used herein, “alkylaryl” means an alkyl group covalently linked to a substituted or unsubstituted aryl group that is linked to a compound.

As used herein, “alkylene” means a linear or branched chain, saturated, divalent aliphatic hydrocarbon group, (e.g., methylene (—CH₂—) or, propylene (—(CH₂)₃—)).

As used herein, “alkylene” means a linear, branched or cyclic divalent aliphatic hydrocarbon group, and may have from 1 to about 18 carbon atoms, more specifically 2 to about 12 carbons. Exemplary alkylene groups include methylene (—CH₂—), ethylene (—CH₂CH₂—), propylene (—(CH₂)₃—), cyclohexylene (—C₆H₁₀—), methylenedioxy (—O—CH₂—O—), or ethylenedioxy (—O—(CH₂)₂—O—).

As used herein, “alkyne” means a linear or branched chain hydrocarbon having at least one carbon-carbon triple bond.

As used herein, “alkynyl” means a linear or branched chain, monovalent hydrocarbon group having at least one carbon-carbon triple bond (e.g., ethynyl).

As used herein, “alkynylene” means a linear or branched chain divalent aliphatic hydrocarbon that has one or more unsaturated carbon-carbon bonds, at least one of which is a triple bond (e.g., ethynylene).

As used herein, “amide” means a group of the formula C(O)—N(Rx)(Ry) or N—C(O)—Rx, wherein Rx is an alkyl, an alkenyl, an alkynyl, a cycloalkyl or an aryl group; and Ry is hydrogen or any of the groups listed for Rx.

As used herein, “aryl” refers to a hydrocarbon group having an aromatic ring, and includes monocyclic and polycyclic hydrocarbons wherein the additional ring(s) of the polycyclic hydrocarbon may be aromatic or nonaromatic (e.g., phenyl or napthyl).

As used herein, “arylalkyl” means a substituted or unsubstituted aryl group covalently linked to an alkyl group that is linked to a compound (e.g., a benzyl is a C7 arylalkyl group).

As used herein, “arylalkylene” group is an aryl group linked via an alkylene moiety. The specified number of carbon atoms (e.g., C7 to C30) means the total number of carbon atoms present in both the aryl and the alkylene moieties. Representative arylalkyl groups include, for example, benzyl groups.

As used herein, “arylene” means a divalent group formed by the removal of two hydrogen atoms from one or more rings of an arene, wherein the hydrogen atoms may be removed from the same or different rings (e.g., phenylene or napthylene).

As used herein, “aryloxy” means an aryl moiety that is linked via an oxygen (i.e., —O-aryl).

As used herein, an asterisk (i.e., “*”) denotes a point of attachment, e.g., a position linked to the same or different atom or chemical formula.

As used herein, “cycloalkylene” means a divalent radical formed by the removal of two hydrogen atoms from one or more rings of a cycloalkyl group (a nonaromatic hydrocarbon that comprises at least one ring).

As used herein, “cycloalkynyl” means an aliphatic monocyclic or polycyclic group having at least one carbon-carbon triple bond, wherein all ring members are carbon (e.g., cyclohexynyl).

As used herein, “cycloalkenylene” means an aliphatic 5-15-membered monocyclic or polycyclic, divalent radical having at least one carbon-carbon double bond, which comprises one or more rings connected or bridged together. Unless disclosed otherwise, the cycloalkenylene radical can be linked at any desired carbon atom provided that a stable structure is obtained. If the cycloalkenylene radical is substituted, this may be so at any desired carbon atom, once again provided that a stable structure is obtained. Examples thereof are cyclopentenylene, cyclohexenylene, cycloheptenylene, cyclooctenylene, cyclononenylene, cyclodecenylene, norbornenylene, 2-methylcyclopentenylene, and 2-methylcyclooctenylene.

As used herein, “cycloalkyl” means a monovalent group having one or more saturated and/or partially saturated rings in which all ring members are carbon (e.g., cyclopropyl, cyclobutyl, cyclopentyl, cyclohexyl, cycloheptyl, cyclooctyl, and partially saturated variants of the foregoing, such as cycloalkenyl groups (e.g., cyclohexenyl) or cycloalkynyl groups.

As used herein, “cycloalkenyl” means a monovalent group having one or more rings and one or more carbon-carbon double bond in the ring, wherein all ring members are carbon (e.g., cyclopentyl and cyclohexyl).

As used herein, the prefix “hetero” means that the compound or group includes an atom that is a heteroatom (e.g., 1, 2, or 3 heteroatom(s)), wherein the heteroatom(s) is each independently N, O, S, Si, or P.

Reference herein is made to various heterocyclic groups. Within such groups, the term “hetero” means a group that comprises at least one ring member that is a heteroatom (e.g., 1 to 4 heteroatoms, each independently N, O, S, P, or Si). In each instance, the total number of ring members may be indicated (e.g., a 3- to 10-membered heterocycloalkyl). If multiple rings are present, each ring is independently aromatic, saturated, or partially unsaturated, and multiple rings, if present, may be fused, pendant, spirocyclic or a combination thereof. Heterocycloalkyl groups comprise at least one non-aromatic ring that contains a heteroatom ring member. Heteroaryl groups comprise at least one aromatic ring that contains a heteroatom ring member. Non-aromatic and/or carbocyclic rings may also be present in a heteroaryl group, provided that at least one ring is both aromatic and contains a ring member that is a heteroatom.

As used herein, a “heteroalkyl” group is an alkyl group that comprises at least one heteroatom covalently bonded to one or more carbon atoms of the alkyl group. Each heteroatom is independently chosen from N, O, S, Si, or P.

As used herein, “heteroarylalkyl” means a heteroaryl group linked via an alkylene moiety.

As used herein, “heteroarylene” means a divalent radical formed by the removal of two hydrogen atoms from one or more rings of a heteroaryl moiety, wherein the hydrogen atoms may be removed from the same or different rings (preferably the same ring), each of which rings may be aromatic or nonaromatic.

As used herein, “independently” indicates that the variable, which is independently applied, varies independently from application to application. Thus, in a compound such as R″XYR″, wherein R″ is “independently carbon or nitrogen,” both R″ can be carbon, both R″ can be nitrogen, or one R″ can be carbon and the other R″ nitrogen.

As used herein, “isolated” refers to a composition that includes at least 85% to 90% by weight, specifically 95% to 98% by weight, and even more specifically, 99% to 100% by weight of a particular compound in the composition, the remainder comprising other chemical compounds.

As used herein, “substituted” means a compound or radical substituted with at least one (e.g., 1, 2, 3, 4, 5, 6 or more) substituents independently selected from a halide (e.g., F⁻, Cl⁻, Br⁻, I⁻), a hydroxyl, an alkoxy, a nitro, a cyano, an amino, an azido, an amidino, a hydrazino, a hydrazono, a carbonyl, a carbamyl, a thiol, a C1 to C6 alkoxycarbonyl, an ester, a carboxyl, or a salt thereof, sulfonic acid or a salt thereof, phosphoric acid or a salt thereof, a C₁ to C₂₀ alkyl, a C₂ to C₁₆ alkynyl, a C₆ to C₂₀ aryl, a C₇ to C₁₃ arylalkyl, a C₁ to C₄ oxyalkyl, a C₁ to C₂₀ heteroalkyl, a C₃ to C₂₀ heteroaryl (i.e., a group that comprises at least one aromatic ring, wherein at least one ring member is other than carbon), a C₃ to C₂₀ heteroarylalkyl, a C₃ to C₂₀ cycloalkyl, a C₃ to C₁₅ cycloalkenyl, a C₆ to C₁₅ cycloalkynyl, a C₅ to C₁₅ heterocycloalkyl, or a combination including at least one of the foregoing, instead of hydrogen, provided that the substituted atom's normal valence is not exceeded.

The articles and processes herein are further illustrated by the following examples, which are non-limiting.

### EXAMPLES

### Example 1

### Foam Substrate with Intumescent Coating

A commercially available foam was provided as a substrate to coated with an intumescent coating. The foam was a polyether-based polyurethane with nominal air permeability of 80 m/min. The following procedure was used to produce a coating that included potato starch (commercially available from Bob's Red Mill), sodium polyborate (InCide® Technologies Boron #10, SPB), and sodium montmorillonite clay (Southern Clay Products Sodium Cloisite®, MMT) on a polyurethane comparative foam. The composition to be deposited on the foam was prepared by making the SPB solution, then adding MMT, and then adding the starch. Several composition were made, and some compositions did not include each component. In one composition, the composition did not include SPB so an MMT solution was made with subsequent addition of starch. All deposition and wash compositions were water-based and were prepared using water purified from a Nanopure II system (18·2 MΩcm, pH of 5·8, Sybron/Barnstead).

This procedure was used to create 100 mL of a 3% starch, 11.5% SPB, and 2% MMT solution. The solution was heated (60° C.) and stirred until the SPB fully dissolved and the reaction to form SPB was complete (30 min). MMT powder (2 mass of the current total mixture) was added to the SPB solution. The SPB-MMT solution was stirred for a couple hours. The starch powder (3 mass % of the current total mixture) was added to the SPB-MMT solution. Then, the solution was heated (90° C.) and stirred until the solution formed a gel. Coating began once the solution cooled to 50° C. The foam was squeezed and released several times in the solution, then left to soak. After 2 min of soaking, the excess material was squeezed out of the sample and the sample was dried overnight at 70° C. in an air convection oven.

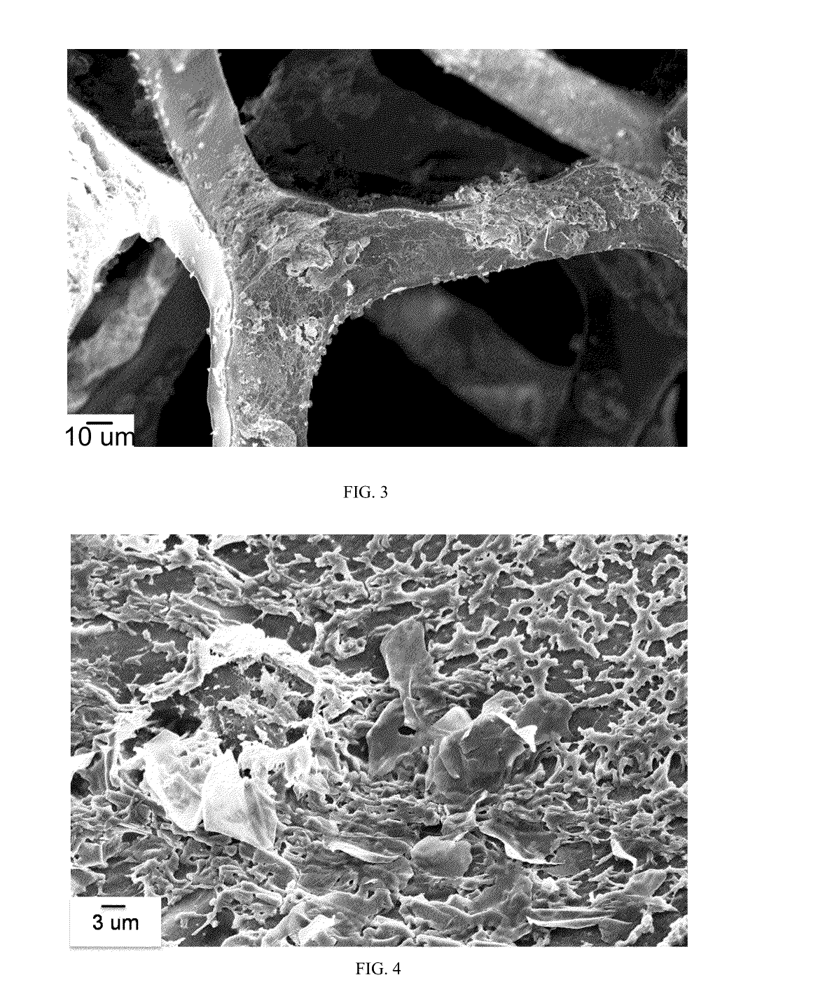

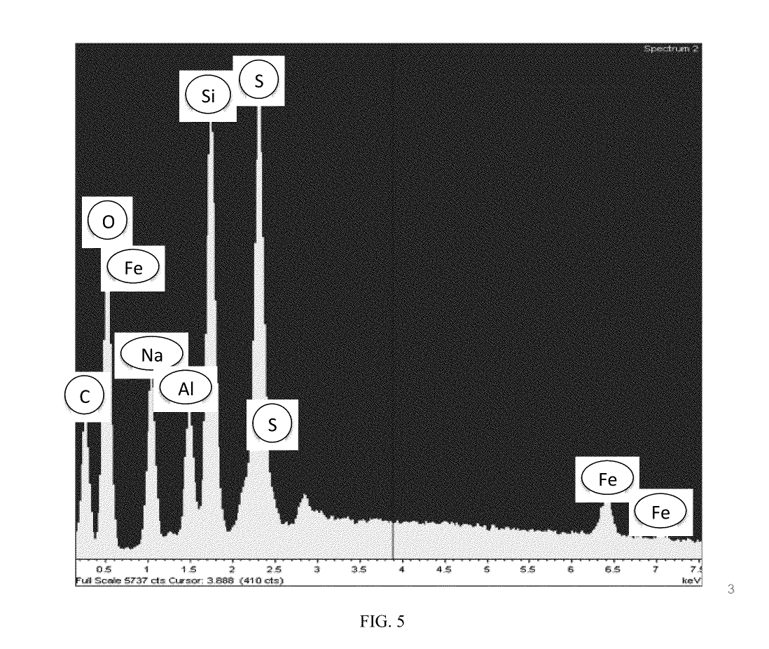

FIG. 3 shows a scanning electron microscope (SEM) micrograph of starch-SPB-MMT coated polyurethane foam that was produced following the procedure described above. The entire surface of the foam is covered by the coating such that the foam had no exposed surface. FIG. 4 shows a higher magnification SEM image of the coating shown in FIG. 3. FIG. 5 shows a graph of intensity versus energy for data acquired by subjecting the coated foam to elemental analysis using an EDEX spectrometer. Elemental analysis provided evidence that the coating included MMT (Fe, Si, Al, and Na), SPB (S), and starch (C and O).

Thermal testing was conducted using cone calorimetry and smolder ignition testing test. Cone calorimetry was conducted using a standard testing procedure according to ASTM standard E-1354-07 with a dual cone calorimeter operated at an incident target flux of 35 kW/m² and an exhaust flow of 24 L/s. A cone size sample (5 cm×5 cm×5 cm) was placed in a pan constructed from heavy gauge aluminum foil. Sides and bottom of the sample were covered by aluminum foil, but the top surface was exposed to the cone heater. The external flux caused the sample to pyrolyze. Once sufficient fuel (pyrolysis products) were produced, ignition (caused by a spark igniter) occurred, and the sample combusted and pyrolyzed further. Heat release rate (HRR) as a function of time was recorded until combustion ceased. In addition to HRR data curves other parameters were reported and included time to ignition (TTI), maximum amount (peak) of heat released during the test (PHHR), time after ignition to reach the PHRR (t-PHRR), total amount of heat released during the test (THR), and average amount of heat released during the test (AHRR).

Smolder ignition testing was conducted as described in NIST Technical Note 1747 (http://nylpubs.nist.gov/nistpubs/TechnicalNotes/NIST.TN.1747.pdf). The components of the test included a blue denim cover fabric, a cigarette (available from the U.S. National Institute of Standards and Technology as NIST 1196 cigarette), and either a comparative foam or coated foam, i.e., an article.

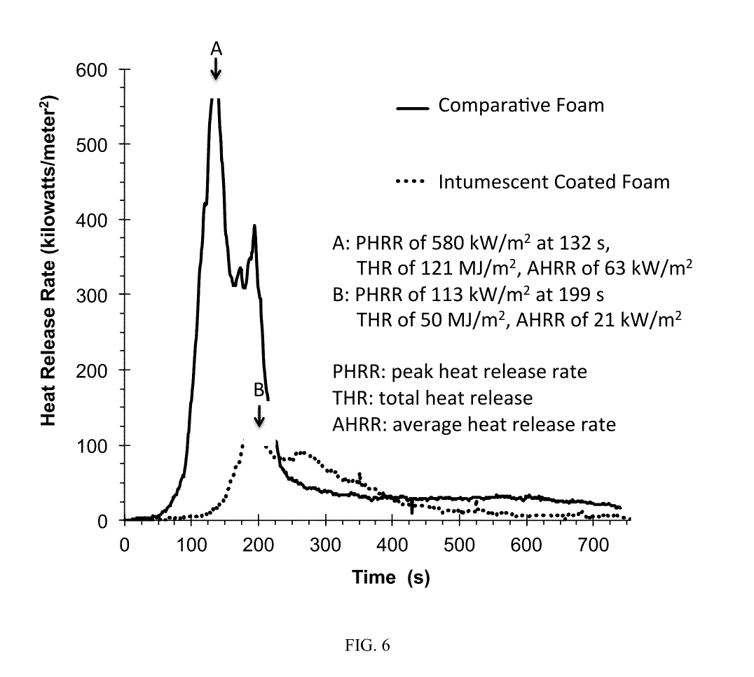

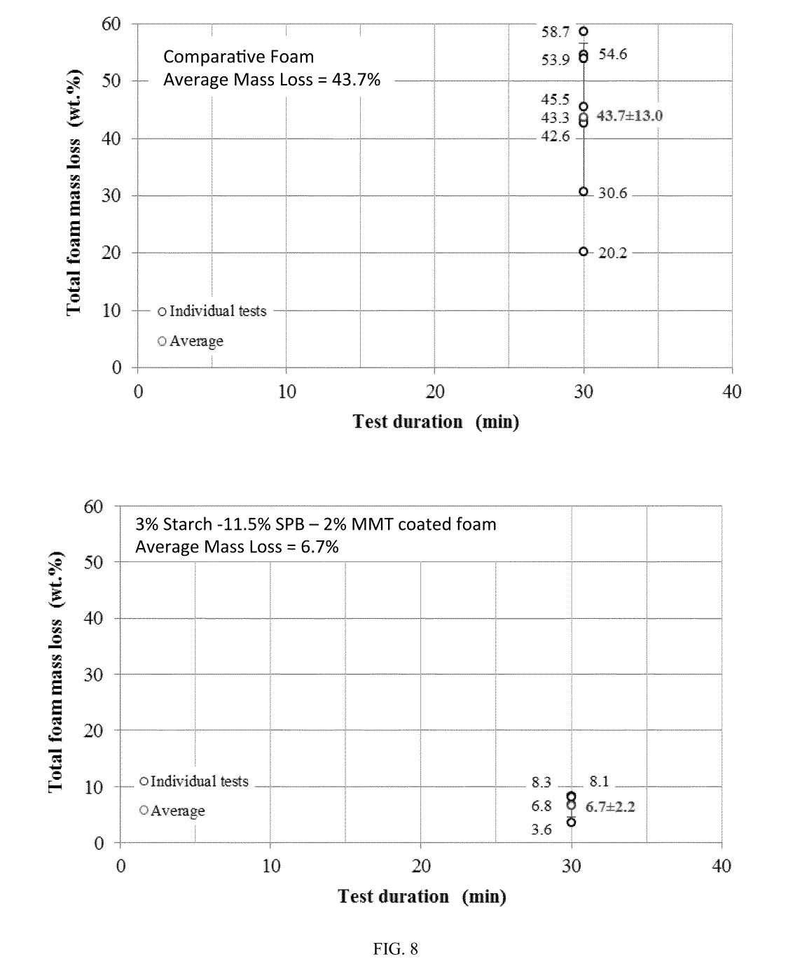

FIG. 6 shows a graph of HRR versus time obtained from cone calorimeter testing of the comparative foam and the starch-SPB-MMT coated polyurethane foam that was produced following the procedure described above. In FIG. 6, the dotted black line is the starch-SPB-MMT coated polyurethane foam. The starch-SPB-MMT coated polyurethane foam had a PHRR of 113 kW/m² at 199 s (indicate with an arrow as B), a THR of 50 MJ/m², and an AHRR of 21 kW/m².

FIG. 9 is the mass loss from a cigarette ignition test using a starch-SPB-MMT coated polyurethane foam.

In FIG. 9, the average mass loss using a starch-SPB-MMT coated polyurethane foam after 30 min is 6.7% relative to the starting mass of the total tested system (i.e., starch-SPB-MMT coated polyurethane foam and blue denim cover fabric).

### Example 2

### Comparative Foam Substrate

The comparative foam is the same foam described in Example 1.

The thermal testing of the comparative foam was conducted as described in Example 1.

FIG. 6 is a HRR curve obtained from Cone calorimeter testing of the comparative foam and the starch-SPB-MMT coated polyurethane foam that was produced following the procedure described above.

In FIG. 6, the solid black line is the comparative polyurethane foam. The comparative polyurethane foam had a PHRR of 580 kW/m² at 132 s (shown as A), a THR of 121 MJ/m², and an AHRR of 63 kW/m². The dotted line is starch-SPB-MMT coated foam. It caused a decrease of all of these Come measured values (PHRR of 113 kW/m² at 199 s (shown as B), a THR of 50 MJ/m², and an AHRR of 21 kW/m². The starch-SPB-MMT coating also delayed the time to the maximum HRR peak from 132 s (A, comparative foam) to 199 s (B, starch-SPB-MMT coated foam).

FIG. 7 shows a graph of total foam mass loss versus test duration obtained from a cigarette ignition test using a comparative foam. In FIG. 7, the average mass loss using a comparative foam after 30 min is 43.7% relative to the starting mass of the total tested system (i.e., comparative foam and blue denim cover fabric).

### Example 3

### Comparative Foam Substrate with Bilayer Coating

Results of cone reduction for the foam of Example is listed in the second row of Table 1. Table 1 also lists (in row 3 to row 8) recently reported flammability reduction of polyurethane foam that includes a fire resistant coating produced by multilayer assembled coatings, e.g., layer-by-layer (LBL) coatings.

| | # of | Cone Reduction | | |
|---|---|---|---|---|
| Recipes | Layers | PHRR | AHRR | THR |
| 3.0% starch-11.5% SPB-2% MMT | 1 | 66% | 73% | 61% |
| 0.1% PAA/1.0% LDH/0.1% BPEI | 5 | 41% | 79% | 32% |
| 0.1% PAA/0.1% BPEI/1% MMT | 9 | 33% | 78% | 23% |
| 0.5% (PAA + MMT) pH2/0.5% PEI | 10 | 42% | 71% | 15% |
| 0.5% CHI/1% (DNA + MMT) | 20 | 51% | 81% | 13% |
| 0.5% CHI/2% PVS | 20 | 52% | 24% | — |
| PAA/CHI/PPA/CHI | 20 | 55% | — | 20% |

These coatings listed in Table 1 were constructed from synthetic and natural polymers (poly(acrylic acid) (PAA), branched poly(ethylene imine) (BPEI), chitosan (CHI), poly(vinyl sulfonic acid) (PVS), DNA), and layered materials (layered double hydroxides (LDH), MMT). The LbL coatings ranged from 5 monolayers to 20 monolayers and resulted in a PHRR reduction of 33% to 55%, AHRR reduction of 25% to 81%, and THR reduction of 13% to 32%. The one starch-based coatings in Table 1 was produced from the procedure described in Example 1. This had a greater reduction on these properties (66% reduction in PHRR, 73% reduction in AHRR, and 61% reduction in THR).

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive; rather the elements can be used separately or can be combined together under appropriate circumstances.

What is claimed is:

1. An article comprising:
a substrate; and
an intumescent coating to form an intumescent product in response to heating the article, the intumescent coating being disposed on the substrate and comprising:
a primary intumescent precursor comprising a carbohydrate polymer; and
a layered material comprising a silicate mineral, a layered double hydroxide, or a combination comprising at least one of the foregoing.

2. The article of claim 1, wherein the intumescent coating further comprises a secondary intumescent precursor.

3. The composition of claim 1, further comprising an additive.

4. The composition of claim 1, wherein the substrate comprises a polymer, a textile, a metal, a glass, or a combination comprising at least one of the foregoing.

5. The composition of claim 4, wherein the substrate is the polymer, and the polymer comprises a foam.

6. The composition of claim 1, wherein the carbohydrate polymer comprises a polysaccharide, a nucleic acid, or a combination comprising at least one of the foregoing.

7. The composition of claim 1, wherein the layered material is the layered double hydroxide, which comprises a hydrotalcite.

8. The composition of claim 1, wherein the layered material is the silicate mineral, which comprises a phyllosilicate.

9. The composition of claim 2, wherein the secondary intumescent precursor comprises a polymer, a polypeptide, a blowing agent, a cross-linker, an acid source, or combination comprising at least one of the foregoing.

10. The composition of claim 3, wherein the additive comprises a boron source, a plurality of nanotubes, a plurality of nanofibers, a plurality of nanoparticles, a plurality of glass particles, a plurality of ceramic particles, or a combination comprising at least one of the foregoing.

11. The composition of claim 3, wherein the first intumescent precursor is present in the intumescent coating in an amount from 1% to 90%, based on a weight of the intumescent coating.

12. The composition of claim 3, wherein the layered material is present in the intumescent coating in an amount from 2% to 99%, based on a weight of the intumescent coating.

13. The composition of claim 3, wherein the second intumescent precursor is present in the intumescent coating in an amount from 0% to 90%, based on a weight of the intumescent coating.

14. The article of claim 2, wherein the primary intumescent precursor and the secondary intumescent precursor are independently a carbon source, a blowing agent, an acid source, or a combination comprising at least one of the foregoing.

15. The article of claim 1, wherein the intumescent coating is a product of disposing on the substrate a liquid composition comprising the primary intumescent precursor and the layered material, such that the layered material is dispersed among the first intumescent precursor.

16. The article of claim 1, wherein the article has a percentage heat release rate that is less than or equal to 100.

17. The article of claim 1, wherein the article and the substrate have a substantially similar flexibility, fluid permeability, or a combination comprising at least one of the foregoing.

18. A composition comprising:
a solvent;
a primary intumescent precursor to contact a substrate and to form an intumescent coating on the substrate, the primary intumescent precursor being disposed in the solvent and comprising a carbohydrate polymer; and
a layered material to be dispersed among the primary intumescent precursor in the intumescent coating on the substrate, the layered material being disposed in the solvent and comprising a silicate mineral, a layered double hydroxide, or a combination comprising at least one of the foregoing.

19. The composition of claim 18, further comprising:
a secondary intumescent precursor to combine with the primary intumescent precursor to form the intumescent coating on the substrate; and
a substrate disposed in the solvent,
wherein the substrate is substantially insoluble in the solvent.

20. A process for forming an article, the process comprising:
forming a liquid composition by:
disposing in a solvent a primary intumescent precursor comprising a carbohydrate polymer; and
disposing in the solvent a layered material comprising a silicate mineral, a layered double hydroxide, or a combination comprising at least one of the foregoing;
contacting a substrate with the liquid composition; and
forming an intumescent coating on the substrate to form the article.
